(19) United States
(12) Patent Application Publication
(10) Pub. No.: US 2010/0005278 A1
(43) Pub. Date: Jan. 7, 2010

(54) DEVICE AND METHOD FOR CONTROLLING AN INTERNAL STATE OF INFORMATION PROCESSING EQUIPMENT

(75) Inventor: Takenobu TANI, Kyoto (JP)

Correspondence Address: MCDERMOTT WILL & EMERY LLP, 600 13TH STREET, NW, WASHINGTON, DC, 20005-3096, US

(73) Assignee: Panasonic Corporation, Osaka (JP)

(21) Appl. No.: 12/534,377

(22) Filed: Aug. 3, 2009

Related U.S. Application Data
(63) Continuation of application No. 11/067,933, filed on Mar. 1, 2005.

(30) Foreign Application Priority Data
Mar. 2, 2004 (JP) 2004-058056

(51) Int. Cl. G06F 15/00

(52) U.S. Cl. 712/220; 712/E09.062

(57) ABSTRACT

The state control device for controlling an internal state of information processing equipment includes a scenario table, an information recorder, an information player and a state change controller. The information recorder acquires sync information and one item or a plurality of items of state information from the information processing equipment and records the acquired sync information and state information in association with each other in the scenario table. The information player, receiving sync information from the information processing equipment, acquires state information associated with sync information corresponding to the received sync information, among the sync information stored in the scenario table, from the scenario table, and supplies the acquired state information to the state change controller. The state change controller controls the inside of the information processing equipment based on the state information received from the information player. The sync information is information for identifying an execution state of the information processing equipment at a given time point, and the state information is information representing an internal state of the information processing equipment at a given time point synchronous with the sync information.

### CROSS-REFERENCE TO RELATED APPLICATIONS

This application claims priority under 35 U.S.C. §119 on Patent Application No. 2004-58056 filed in Japan on Mar. 2, 2004, the entire contents of which are hereby incorporated by reference.

### BACKGROUND OF THE INVENTION

The present invention relates to a state control device and method for information processing equipment, such as microprocessors (including microcomputers, microcontrollers and digital signal processors) composed of a single processor or a plurality of processors, sequencers and static-configured/dynamic-reconfigurable logics, which executes sequential processing according to a basic state element (for example, a program counter value, a counter value and a sequencer state value) and a change in the state element. Although processors are herein exemplified mainly, the present invention is applicable to information processing equipment as defined above in general.

Conventionally, to implement software processing by hardware, information processing equipment such as microprocessors is generally used. For enhancement of software productivity, the conventional custom hardware orientation is now shifting to such hardware styles that have microprocessors composed of a single processor or a plurality of processors, sequencers, high-level synthesis static-configured/dynamic-reconfigurable logics and the like as the center, in which software processing is mapped to hardware and executed, although software drive is essentially mainstream.

In recent years, in hardware, the circuit scale and the operating frequency keep on increasing with increase of requests for software processing, as is typified by multimedia processing such as sound and moving images. The increases in circuit scale and operating frequency cause increase in power consumption and increase in various types of processing penalties due to increased pipeline stages.

For power reduction, instructions and state information are conventionally decoded in each execution cycle in hardware to achieve clock gating and circuit operation stop control.

To suppress instruction decoding in each cycle, control as disclosed in Japanese Patent No. 1959871, for example, is generally performed, in which a repetition (loop) portion high in processing frequency is specified and operation of a circuit portion unused during processing of the loop is stopped in loop units.

To suppress the processing penalties due to increased pipeline stages, memory data is preloaded by explicit designation of instructions.

Also, in branch instructions involving conditional execution, such as conditional branch instructions, speculative fetch and prefetch of branch target instructions are generally performed to conceal penalties.

However, in the conventional method for reducing power consumption by decoding instructions and states described above, power is consumed by the decode circuit itself and also insertion of a decode logic blocks speedup of circuits. In particular, in upstream stages of the pipeline, in which the number of logic stages available for low-power circuits is strictly limited, power control is difficult in consideration of the speed.

To overcome the above problem, in the method disclosed in the aforementioned Japanese Patent No. 1959871, for example, the loop unit is handled as the object for power control, to solve the problems related to decoding in each cycle and the decoding speed. This method is advantageous in the sense that a loop for which processing is made at high frequency is used as the object for control.

However, the above method, in which the entire loop is the object for control, fails to attain sufficient power reduction in the current information processing equipment. The reason is that, when the entire loop is the object for control, effective power reduction control is unattainable if the loop includes an instruction important in performance. Also, a complicate loop fails to be the object for control.

In realistic applications typified by those in recent multimedia processing, sufficient stop control is unattainable as in the following example. When a specific instruction as the object is not included in a loop as the processing unit, the relevant instruction decoder and related block may be stopped.

However, in information processing equipment intended to enhance the performance, an instruction that is never used in a loop unit is inherently a less necessary instruction and is not influential in the circuit scale, and thus the power reduction effect obtained by stopping the relevant circuits will be small. On the contrary, there seldom occurs a case permitting stop of instructions used at high frequency, such as instructions of data memory access and multiply-accumulate operation.

FIG. 42A shows an exemplary assembler program related to loop processing. In this example, with LOOP instruction, the range from the next instruction through the instruction of L_END label is executed repeatedly.

As shown in FIG. 42A, memory access (LD instruction) is executed in only two cycles among the five cycles, which is therefore unnecessary in the remaining three cycles. Likewise, multiply-accumulate operation (MAC instruction) is unnecessary in four cycles among the five cycles. In either case, however, the instruction that appears once in a loop cannot be used as the object for batch control.

As described above, it is an instruction like the memory access instruction that will actually be effective by performing the loop-unit stop. There are not many other objects that can be controlled effectively.

As another method, issue of an unnecessary instruction may be stopped in each loop in accordance with the maximum number of instructions issued per cycle in the loop in information processing equipment permitting parallel execution of instructions. In this case, as in the case described above, there always exists a cycle that issues nearly largest number of instructions in a loop in information processing equipment intended to enhance the performance. Therefore, the loop is limited by the largest-issuing cycle even though the other cycles issue a small number of instructions, and thus the control for the entire loop does not work effectively in actual applications.

For example, in FIG. 42B, in which the maximum degree of parallelism is 2 although the degree of parallelism is 1 in most cycles, it is ineffective to control the number of instructions issued per cycle with the maximum number in loop units.

The loop-unit control methods also have problems in instruction sets and instruction control.

In general, a digital signal processor (DSP) has a loop-dedicated instruction of executing a specific instruction string repeatedly (corresponding to the LOOP instruction in the example of FIG. 42A).

However, currently mainstream processors typified by RISC processors generally have no loop-dedicated instruction, but form a loop structure with a branch instruction (FIG. 42C shows an exemplary program). In this case, it is difficult to determine whether or not a loop is currently being processed, and thus it is not allowed to perform the power reduction control under recognition that the processing is currently inside a loop.

The loop control is also difficult when an instruction that changes the processing flow, such as a conditional branch instruction, exists in a loop. State control must be suppressed when a branch instruction is satisfied. In general, therefore, it is difficult to perform the power reduction control when a branch instruction exists in a loop. Existence of a branch instruction in a loop is never a special case, as shown in FIGS. 43A and 43B.

As described above, with such simple loop-unit control, stop control does not effectively work in many applications including multimedia applications.

The loop-unit control also fails to provide sufficient stop control for a software structure, not a simple loop structure, such as an application for decoding variable-length codes including frequent use of branches, for example, in which the control flow is frequently changed but individual instructions themselves are executed at high frequencies in average.

As for the problem of decrease in operation speed, there is conventionally considered a method of decoding instruction codes in advance and storing the decoded results in the upstream stages of the pipeline, like a predecode cache. However, this method merely increases the information decoding speed for individual instructions, but fails to perform control dependent on inter-instruction continuity, like data hazard detection.

Also, the above method can merely retrieve instruction decode information corresponding to the program counter value, that is, the instruction address value. Information is never supplied before the program counter value thereof is given.

Therefore, the predecode cache method also fails to serve as essential countermeasures against the decrease in operation speed in upstream stages of the pipeline.

The predecode method naturally requires an investment of a considerably large circuit scale, and this will be detrimental to the intended power reduction and circuit scale reduction.

As for the processing penalties, there is known a method in which a software developer explicitly describes a prefetch instruction of acquiring memory access data in advance.

The above method however places a large burden on the software developer for enhancement of performance. In addition, degradation in performance due to explicit instruction insertion itself is not negligible.

With the recent compiler technology, there has been introduced a method of statically scheduling and locating a prefetch instruction. However, the results obtained by this method, including a complicate branch structure, do not necessarily provide the same performance as that obtained by an assembly program developer.

To minimize penalties in a branch instruction, there is a method in which a branch target instruction is speculatively fetched irrespective of whether or not the condition of a conditional branch is satisfied. In another method for further minimizing penalties, a branch target instruction group is stored in advance in a buffer called a branch target buffer and retrieved whenever necessary.

Either of the above methods requires an investment of a considerably large circuit scale, and this is detrimental to the intended power reduction and circuit scale reduction.

As described above, the increase in pipeline stage due to increase in operation frequency increases various processing penalties. This problem, as well as other problems such as drive of an extended accelerator of information processing equipment and state change of a dynamic reconfigurable logic, are common problems in the software-processing type hardware.

### SUMMARY OF THE INVENTION

An object of the present invention is providing a state control device and method that can change a state of information processing equipment while enhancing software productivity without causing extensive circuit increase or reduction in operation speed, to thereby attain power reduction and enhancement in processing performance.

The state control device of the present invention is a device for controlling an internal state of information processing equipment, including a scenario table, an information recorder, an information player and a state change controller. The information recorder acquires sync information and one item or a plurality of items of state information from the information processing equipment and records the acquired sync information and state information in association with each other in the scenario table. The information player, receiving sync information from the information processing equipment, acquires state information associated with sync information corresponding to the received sync information, among the sync information stored in the scenario table, from the scenario table, and supplies the acquired state information to the state change controller. The state change controller controls the inside of the information processing equipment based on the state information received from the information player. The sync information is information for identifying an execution state of the information processing equipment at a given time point, and the state information is information representing an internal state of the information processing equipment at a given time point synchronous with the sync information.

With the state control device described above, information essentially required in each processing cycle is predicted to enable synchronous, selective and continuous change of a state, without necessarily requiring information processing such as computation and decoding in the relevant cycle, whereby only an essentially necessary portion is validated, or essentially necessary information/state is prepared in advance, in each processing cycle, and this processing is performed sequentially.

In particular, the present invention uses the feature of processors, among various types of information processing equipment, that the instruction execution style is often determined uniquely for a given instruction string. This applies not only to static instruction schedulable single-instruction issue processors and VLIW processors but also to superscalar processors.

For example, in the inventive method, complete state decoding and logical computation is not necessary. Only the state that can be stopped without fail may be recorded, and prerecorded information can be discarded if regarded unnecessary. Hence, effective implementation with a small circuit scale is ensured.

The present invention is particularly effective for locally high-load portions, such as so-called hot spots, in multimedia processing and large-scale computation.

In such hot spots, in which the range of several cycles to several tens of cycles is locally executed at high frequency, a large effect can actually be obtained only with recording/playing of several sets of scene information.

As described above, according to the present invention, a state of information processing equipment can be changed while enhancing software productivity without causing extensive circuit increase or decrease in operation speed, to thereby attain power reduction and enhancement in processing performance.

Necessary hardware operation can be started prior to acquisition of individual information and without acquisition of individual information. Also, essential hardware drive can be realized with a minimum operating portion without large-scale logic activation, to thereby attain enhancement in processing performance and power reduction.

The present invention is widely applicable independent of the hardware basic configuration. Accordingly, it is easy to add/remove implementation to/from hardware, software compatibility is maintained, software productivity is enhanced, and yet power reduction and enhancement in processing performance can be attained easily in a safer manner.

### BRIEF DESCRIPTION OF THE DRAWINGS

FIG. 1 is a block diagram of a state control device for a microprocessor in Embodiment 1 of the present invention.

FIG. 2 is a view illustrating an operation concept on information recording in the microprocessor and a scenario control section shown in FIG. 1.

FIG. 3 is a timing chart for demonstrating the operation of the microprocessor and the scenario control section shown in FIG. 1.

FIG. 4 is a view for demonstrating an operation concept on control of states of the microprocessor with the scenario control section in the microprocessor provided with the state control device of Embodiment 1 of the present invention.

FIG. 5 is a view showing an exemplary logical layout of a scenario table.

FIG. 6 is a view showing an exemplary logical layout of the scenario table.

FIG. 7 is a view showing an exemplary logical layout of the scenario table.

FIG. 8 is a view for demonstrating the timing relationship between sync information obtained from the microprocessor and control information from the scenario control section.

FIG. 9 is a view for demonstrating the timing relationship between sync information obtained from the microprocessor and control information from the scenario control section.

FIG. 10 is a view for demonstrating the timing relationship between sync information obtained from the microprocessor and control information from the scenario control section.

FIG. 11 is a view showing an example of the timing between supply of control information from the scenario control section and the detailed operation of the microprocessor.

FIG. 12 is a timing chart of the operation of recording and playing scene information after performing timing adjustment between pipeline stages in the microprocessor.

FIG. 13 is a view showing a mechanism of invalidating recorded scene information in the scenario control section.

FIG. 14 is a timing chart for achieving speculative and conditional playing of scene information in the scenario control section.

FIG. 15 is a timing chart for achieving correction and re-recording (back annotation) of already-recorded scene information in the scenario control section.

FIG. 16 is a timing chart for performing composition in which a representative of information is given based on already-recorded scene information.

FIG. 17 is a view showing pipeline stages in the microprocessor assumed in Embodiment 1.

FIG. 18 is a view showing an exemplary bird's-eye configuration related to an information supply and control method by the scenario control section and the microprocessor, in the state control device of the present invention.

FIG. 19 is a view showing an instruction issue pattern in ID stages and an instruction issue pattern at respective times in the microprocessor.

FIG. 20 is a view showing instruction issue and decode-related part of the microprocessor in FIG. 19, together with the scenario control section.

FIG. 21 is a view showing an example of state control for branch control and address calculation related to data memory access, in a microprocessor provided with the state control device of Embodiment 1.

FIG. 22 is a view showing an example of state control for data hazard control and data forwarding control in a microprocessor provided with the state control device of Embodiment 1.

FIG. 23 is a view showing an example of state control for data flow control of data forwarding in a microprocessor provided with the state control device of Embodiment 1.

FIG. 24 is a view showing an example of state control for data memory access in a microprocessor provided with the state control device of Embodiment 1.

FIG. 25A is a view showing an example of state control for default/path selection in a microprocessor provided with the state control device of Embodiment 1.

FIG. 25B is a view showing an example of state control for computation localization in a microprocessor provided with the state control device of Embodiment 1.

FIG. 26 is a view showing an exemplary logical layout of the scenario table.

FIG. 27 is a view showing an exemplary logical layout of the scenario table.

FIG. 28 is a view showing an exemplary logical layout of the scenario table.

FIG. 29 is a view showing an instruction program used in an example for demonstrating transition of a hardware internal state and the details and timing of record and play information, in the microprocessor and the scenario control section.

FIGS. 30A to 30D are views showing examples of operation timing in respective time cycles at time-series execution of the instruction program of FIG. 29 in the microprocessor.

FIG. 31 is a view showing an example of details of the scenario control section in FIG. 1.

FIG. 32 is a view showing another example of details of the scenario control section in FIG. 1.

FIG. 33 shows an example of the most effective method for detecting a high-load state automatically, actuating upon detection automatically and starting record and play operations.

FIGS. 34A to 34D are views for demonstrating a technique of performing record and play operations selectively for a specific program portion in the scenario control section.

FIG. 35A shows an example in which operation corresponding to SET_COOL_STREAM instruction in FIG. 34D is performed with a general instruction, not a dedicated instruction. FIG. 35B shows an example in which a specific instruction is used as an event for determination on whether or not recording/playing is started/terminated. FIG. 35C shows an example in which execution or not of enable control for state change is designated with a compile option of a compiler. FIG. 35D shows an example in which execution or not of enable control for state change is designated with a directive given in a source program.

FIGS. 36A and 36B are views showing configurations for control of a conditional execution instruction in the microprocessor.

FIG. 37 is a view showing an example of conditional execution of an instruction by a predicate method.

FIG. 38 is a flowchart showing an operation procedure of the scenario control section, in particular, a record controller thereof in Embodiment 1.

FIG. 39 is a view showing an example of configuration of a state control device for a microprocessor in Embodiment 2 of the present invention.

FIG. 40 is a timing chart of the operation of the state control device for a microprocessor in Embodiment 2.

FIG. 41 is a view showing another example of configuration of the state control device for a microprocessor in Embodiment 2.

FIGS. 42A to 42C show exemplary assembler programs related to loop processing.

FIGS. 43A and 43B show exemplary assembler programs related to loop processing.

### DESCRIPTION OF THE PREFERRED EMBODIMENTS

Hereinafter, preferred embodiments of the present invention will be described in detail with reference to the accompanying drawings. The same or equivalent components are denoted by the same reference numerals throughout the drawings, and the description thereof is not repeated.

### Embodiment 1

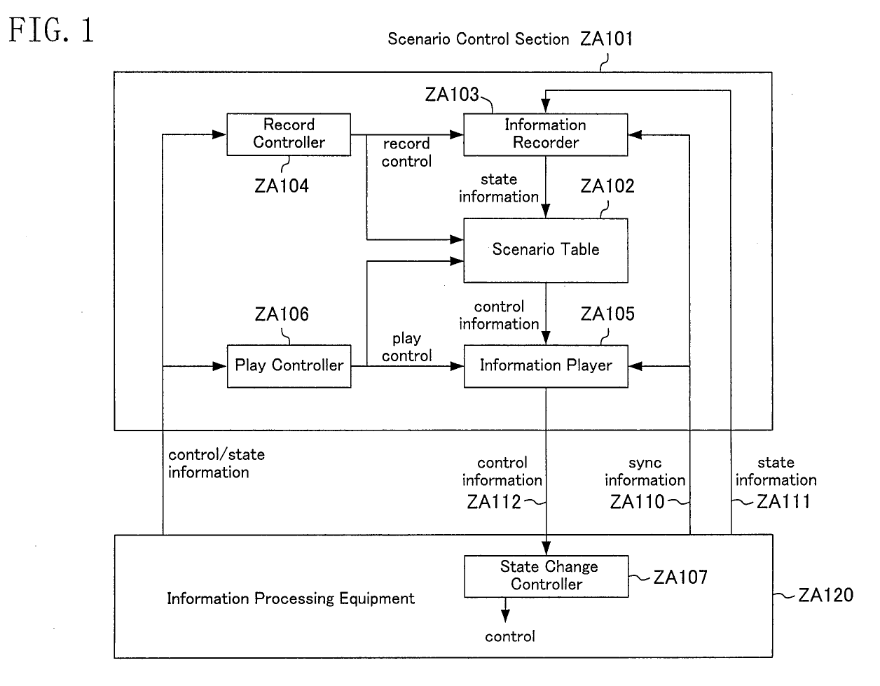

FIG. 1 is a block diagram of a state control device for a microprocessor in Embodiment 1 of the present invention.

A scenario control section ZA101 is connected to a microprocessor ZA120 for performing state control for the microprocessor ZA120. Naturally, the scenario control section ZA101 can be placed inside the microprocessor ZA120. The scenario control section ZA101 includes a scenario table ZA102, an information recorder ZA103, a record controller ZA104, an information player ZA105 and a play controller ZA106.

A state change controller ZA107 is placed inside the microprocessor ZA120. The state change controller ZA107 may otherwise be placed inside the scenario control section ZA101.

The scenario table ZA102 is a device that stores rewritably one set or a plurality of sets of sync information ZA110 as first state information (for example, the program counter value) of the microprocessor ZA120 and a group of a plurality of units of second state information ZA111 in the same cycle or over a plurality of different cycles of the microprocessor ZA120, synchronizing with the sync information ZA110 (herein, the set of associated information is called scene information).

In the following description of examples, the program counter value is used as the sync information ZA110. According to the present invention, however, values other than the program counter value, such as a state value and a counter value, can also be used as the sync information.

The information recorder ZA103 is a device that records the first state information and the second state information group in the scenario table as associated scene information after adjusting the cycle timing as required and correcting the second state information group if necessary.

The record controller ZA104 is a device that selectively instructs the information recorder ZA103 to start and terminate recording to the scenario table ZA102 at the time of given decisive or configurable condition matching and in a given cycle.

The information player ZA105 is a device that can supply predictive control information ZA112 to the microprocessor ZA120 in the same cycle or in a cycle preceding by one cycle or more, based on the second state information group ZA111 associated with the sync information ZA110 recorded in the scenario table ZA102 synchronizing with the sync information ZA110 of the microprocessor ZA120.

The play controller ZA106 is a device that selectively instructs the information player ZA105 to start and terminate supply of the control information ZA112 (this supply is herein referred to as play) at the time of given decisive or configurable condition matching and in a given cycle.

The state change controller ZA107 is a device that controls the inside of the microprocessor ZA120 based on the control information ZA112 supplied from the information player ZA105, without necessarily requiring information processing results in the relevant cycle in the microprocessor ZA120. The state change controller ZA107 is not necessarily placed in the form of a local block in the microprocessor ZA120, but is generally placed in a scattered manner integrally with various decoders and control circuits.

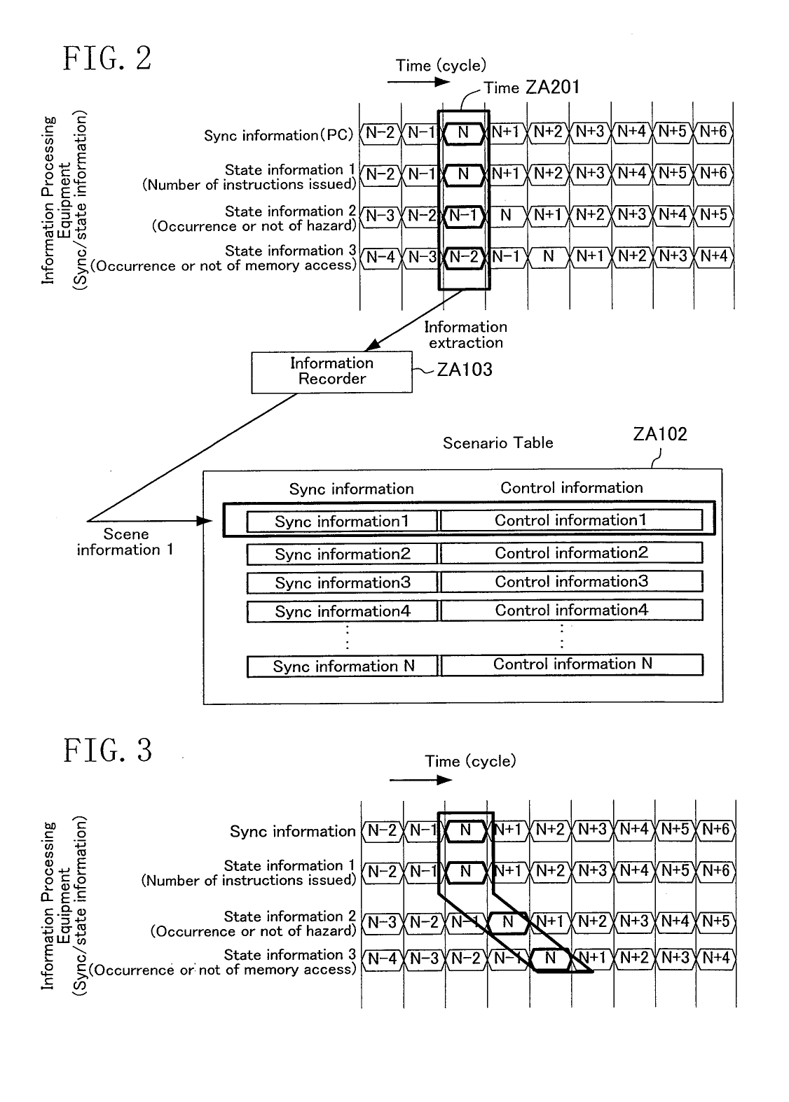

FIG. 2 is a view showing an operation concept on information recording performed by the microprocessor ZA120 and the scenario control section ZA101.

The timing chart in the upper part of FIG. 2 shows time-series changes of the sync information ZA110 and the state information ZA111 of the microprocessor ZA120.

For example, at time ZA201, the sync information ZA110 of the microprocessor ZA120 indicates the program counter value corresponding to the N-th instruction, and state information 1 (in the illustrated example, the number of instructions issued per cycle), state information 2 (in the illustrated example, occurrence or not of hazard) and state information 3 (in the illustrated example, occurrence or not of memory access) as examples of the state information ZA111 respectively indicate the states corresponding to the N-th instruction, the (N−1)th instruction and (N−2)th instruction.

The information recorder ZA103 of the scenario control section ZA101 acquires sync information ZA110 and state information ZA111 at the time ZA201 in the microprocessor ZA120, and stores the information in the scenario table ZA102 as scene information ZA210 after adjusting the stage timing and performing processing such as information validation.

The scenario control section ZA101 is permitted to retrieve scene information ZA210 corresponding to sync information ZA110 as internal information of the microprocessor ZA120 used as the key information, and supply control information ZA112 recorded in the corresponding scene information to the microprocessor ZA120, after performing output enable processing and timing adjustment as required, before the microprocessor ZA120 necessitates the information.

As described above, by supplying scene information ZA210 recorded in advance to the microprocessor ZA120 momentarily and in advance as required, according to the state of the sync information ZA110 of the microprocessor ZA120, the internal state of the microprocessor ZA120 can be changed without necessarily requiring processing of the microprocessor, and as a result, power reduction and enhancement in processing performance can be attained.

Note that according to the present invention, as shown in FIG. 3, the sync information ZA110 and the state information ZA111 of the microprocessor ZA120 acquired as the scene information are not necessarily information at the same time. In the example of FIG. 3, as the state information 2 and the state information 3 among the state information ZA111, the states after one cycle and after two cycles, respectively, may be acquired, and supplied as the scene information after being subjected to timing adjustment.

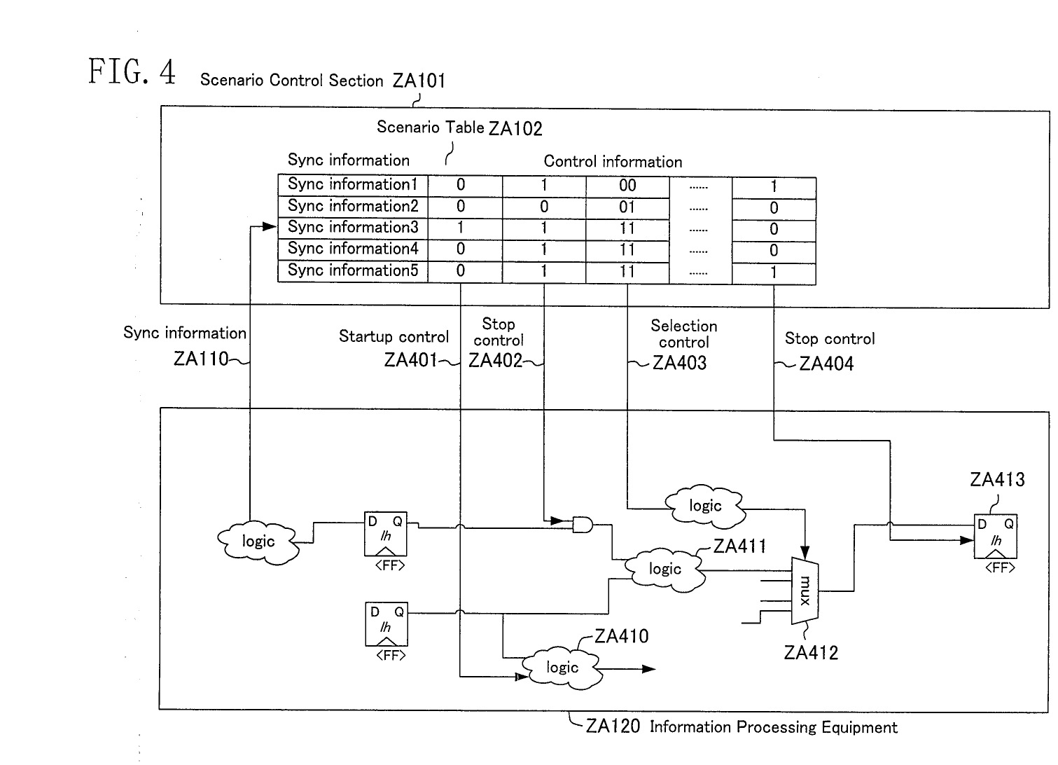

FIG. 4 illustrates an operation concept on control of states of the microprocessor ZA120 with the scenario control section ZA101 in the microprocessor ZA120 provided with the state control device of Embodiment 1 of the present invention. The scenario control section ZA101 outputs control information ZA112 corresponding to sync information ZA110 output from the microprocessor ZA120. In the example of FIG. 4, startup information ZA401, stop information ZA402, selection information ZA403 and stop information ZA404 are output as the control information ZA112.

For example, the startup information ZA401 serves to control a function circuit group ZA410 in the microprocessor ZA120. In the example of FIG. 4, the startup information ZA401 is valid only when the sync information ZA110 of the microprocessor ZA120 is in the state corresponding to sync information 3 in the scenario table ZA102.

Thus, the function circuit group ZA410 is allowed to perform specific operation with the startup information ZA410 only when the sync information ZA110 of the microprocessor ZA120 is in the state corresponding to the sync information 3. This enables execution of startup control for the function circuit group ZA410 in a cycle preceding start of instruction processing in question without necessarily requiring decoding of an internal state of the microprocessor ZA120 such as details of the instruction processing. Using this capability, advance data acquisition and the like can be attained as will be described later.

The stop information ZA402 serves to suppress circuit activation for a function circuit group ZA411 of which operation is not required so frequently. In the illustrated example, the stop information ZA402 is valid when the sync information ZA110 is any other than sync information 2. Thus, activation of the function circuit group ZA411 can be steadily suppressed with the stop information ZA402 when the sync information is any other than the sync information 2. This enables power reduction.

Likewise, the selection information ZA403 is supplied to a multiplexer ZA412 in the microprocessor ZA120. For example, the multiplexer ZA412, which is a 4-input selector, is made to always select an input that will not activate the selector output in a cycle requiring no selector output, to thereby reduce power consumption. In the illustrated example, a path of “11” that is small in input change is selected when the sync information ZA110 of the microprocessor ZA120 is in the state corresponding to sync information 3, 4 or 5, to thereby attain power reduction.

With the stop information ZA404, a write enable signal is supplied to a flip-flop (FF) Z413. For example, in circuit implementation, the stop information ZA404 is a clock gating signal for a clock supplied to each FF. In the illustrated example, clock gating control is performed for the FF ZA413 to suppress data write to the FF when the sync information ZA110 of the microprocessor ZA120 corresponds to sync information 1 or 5, to thereby attain power reduction.

An example of control for the circuits in the microprocessor ZA120 was described with reference to FIG. 4. Naturally, the control is not limited to the startup, stop and selection for logic circuits.

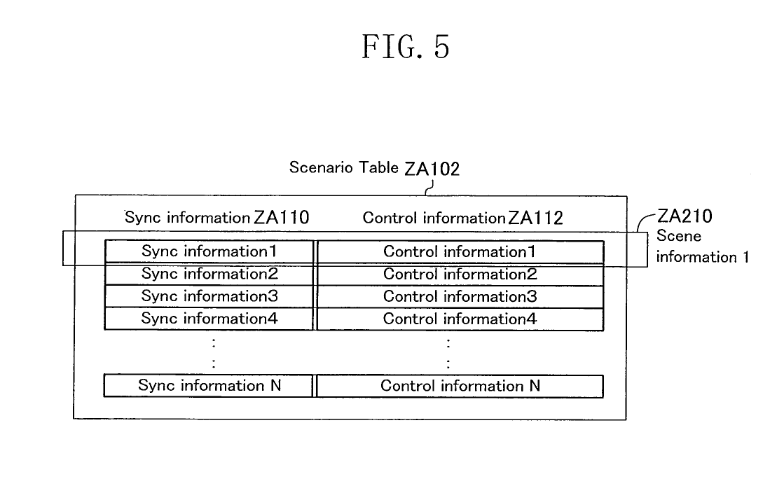

Hereinafter, examples of the logical layout of the scenario table ZA102 will be described with reference to FIGS. 5 to 7.

FIG. 5 shows a general layout of the scenario table ZA102. The scenario table ZA102 stores at least one unit of scene information ZA210 composed of the sync information ZA110 and the control information ZA112.

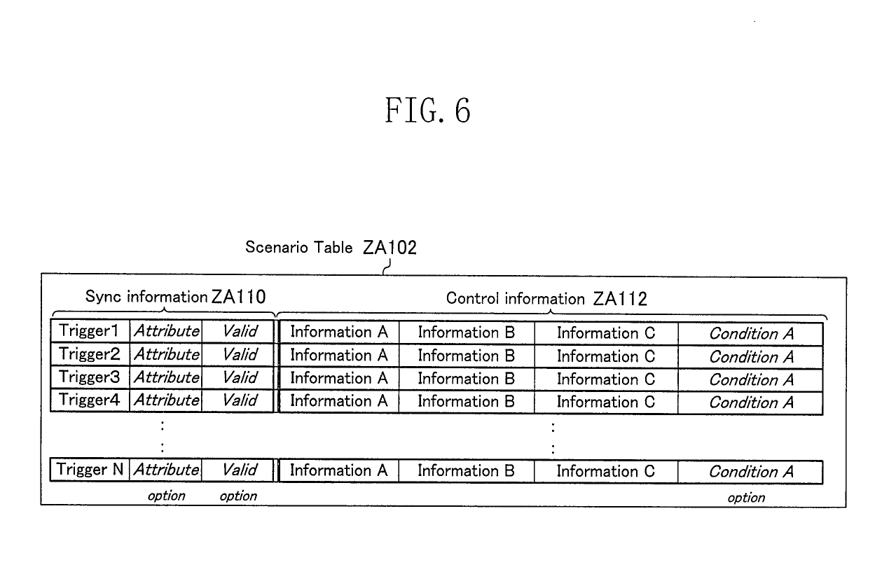

FIG. 6 shows an example of layout of the scenario table ZA102 in which recorded information fields of the sync information ZA110 and the control information ZA112 are expressed in general terms.

Specifically, each item of the sync information (corresponding to sync information i (i=1, 2, . . . ) in FIG. 5) includes a trigger field in which the sync information is generalized and stored, an attribute field in which the type of synchronization of the sync information is stored, and a valid field indicating whether the stored scene information itself is valid data. The attribute field and the valid field may be omitted depending on the actual configuration.

Each item of the control information (corresponding to control information i (i=1, 2, . . . ) in FIG. 5) includes control information fields in which the state information ZA111 is stored after being processed as required and a condition field indicating the type of the information. The condition field may be omitted depending on the actual configuration. In an example, the condition field may be used to store supply risk information (risky bit) on stored information, which will be described later.

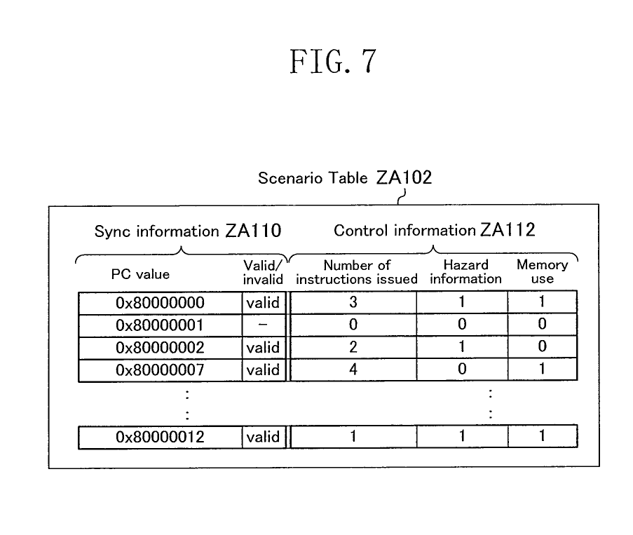

FIG. 7 shows a specific example of the scenario table ZA102. In this example, the sync information is composed of a trigger field and a valid field, and the control information is composed of only control information fields. In the illustrated example, the program counter (PC) value of the microprocessor is adopted as the trigger information. The control information fields represent the number of instructions issued in the microprocessor (number of instructions issued), occurrence or not of a hazard (hazard information) and occurrence or not of data memory access (memory use). An example of operation using this table will be described later.

The example of the scenario table ZA102 described above is just an example of logical layout, and thus it is not required to adopt the illustrated layout in hardware configuration. A specific example of hardware configuration will be described later.

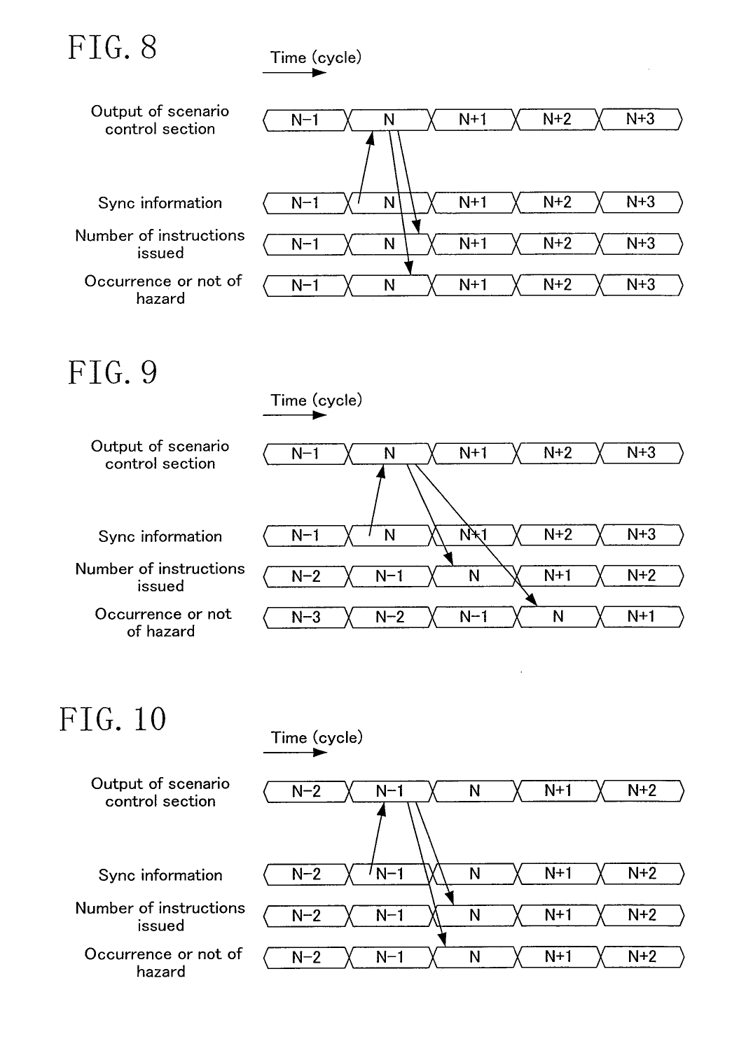

Next, referring to FIGS. 8 to 10, the timing relationship between the sync information ZA110 obtained from the microprocessor ZA120 and the control information given by the scenario control section ZA101 will be described.

FIG. 8 shows an example in which the control information ZA112 corresponding to the sync information ZA110 is output in the same cycle.

In the example of FIG. 8, the scenario control section ZA101 supplies the control information ZA112 to the microprocessor ZA120 in response to the sync information ZA110 of the microprocessor ZA120 in the same cycle.

In the above example, no FF is necessary for adjustment of the timing between pipeline stages in the microprocessor ZA120 both at the recording of the state information ZA111 from the microprocessor ZA120 into the scenario control section ZA101 and at the supply of the control information ZA112 from the scenario control section ZA101 to the microprocessor ZA120. This can provide a compact circuit configuration.

However, supplying information in the same cycle may cause decrease in the operation speed of the microprocessor ZA120 with high possibility.

Even if no problem occurs in operation speed, the following problem occurs. Since the control information is output by propagation in the same cycle, the output of the scenario control section has a minimal signal-uncertain time period in the cycle. This signal-uncertain state, which corresponds to a state of repeating charging/discharging in a circuit configuration with CMOS transistors, for example, leads to increase power consumption and thus is disadvantageous from the standpoint of power reduction.

FIG. 9 shows an example in which the control information ZA112 corresponding to the sync information ZA110 is output one cycle or more behind.

In the example of FIG. 9, in comparison with the example of FIG. 8, although a pipeline FF for stage timing adjustment is necessary at the recording and supply of information, the operation speed is prevented from decreasing because the signal can be supplied at high speed. Also, signal change can be limited to only once in each cycle at worst, and thus this method is advantageous from the standpoint of power reduction.

In the above timing method, however, it is only possible to supply information in a cycle one cycle or more behind the cycle in which the sync information ZA110 of the microprocessor ZA120 is acquired. Therefore, a function of the microprocessor ZA120 performed at the same timing as the generation of the sync information, such as the function of generating the sync information itself, for example, cannot be controlled.

FIG. 10 shows an example in which the control information ZA112 corresponding to the sync information ZA110 is output in advance. With this timing method, control including that for pipeline upstream stages can be performed for the configuration shown in FIG. 9. In this example, the sync information ZA110 and the control information ZA112 are timing-adjusted and stored in advance. For example, in the example of FIG. 10, information at time N is recorded at the time when the sync information ZA110 indicates the state at time N−1. In this way, as the sync information ZA110, for example, information required by a program counter can be supplied in advance before the program counter becomes the originally required value. This permits control for speed-critical stages in the upstream of the pipeline. Also, a state necessary for a given instruction can be prepared far before execution of the given instruction. This is therefore effective in enhancement in processing performance and power reduction.

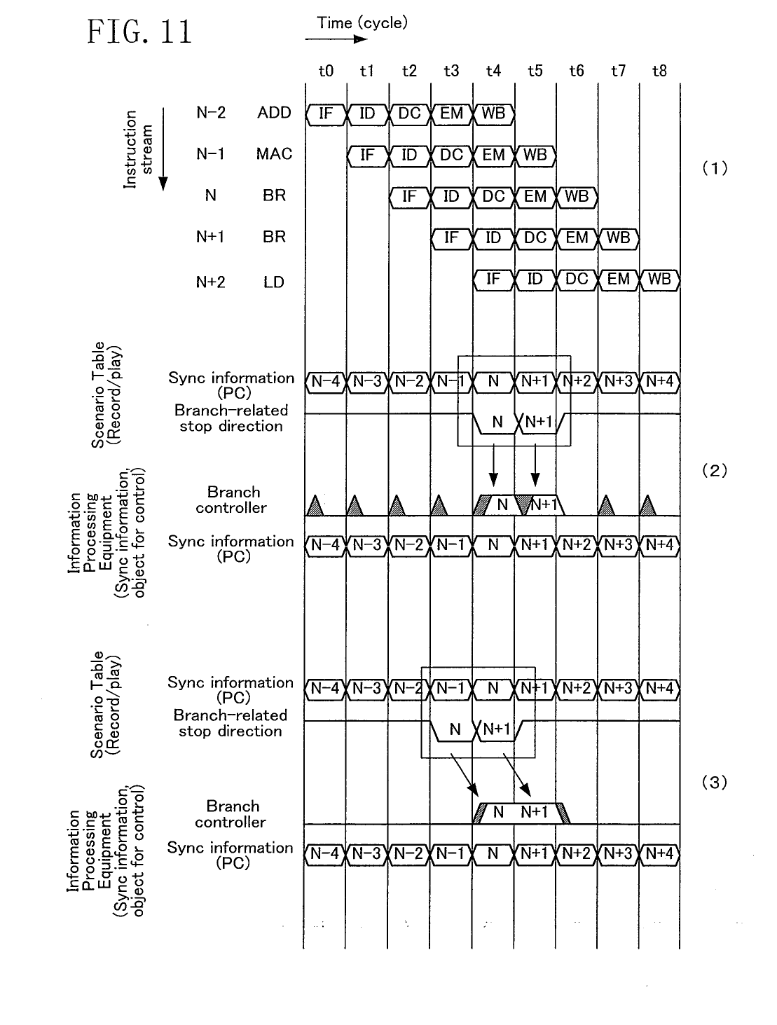

FIG. 11 shows an example of the timing between the supply of the control information ZA112 from the scenario control section ZA101 and the detailed operation of the microprocessor ZA120.

In FIG. 11, part (1) shows the timing of instruction execution by the microprocessor ZA120, part (2) shows the case that the scenario control section ZA101 records/plays information at the timing shown in FIG. 8, and part (3) shows the case that the scenario control section ZA101 records/plays information at the timing shown in FIG. 10.

In part (2) of FIG. 11, the scenario control section ZA101 outputs a branch-related stop directing control signal at time T4 according to the sync information from the microprocessor ZA101. Likewise, a branch-related stop directing control signal is output at time t5.

In the above timing method, a signal-uncertain time is generated in a minimal head time period in each cycle due to logical delay and propagation delay of the signal occurring when the sync information from the microprocessor ZA101 reaches a branch-related function group via the scenario control section. In this time period, charging/discharging may possibly occur repeatedly due to signal transition, as described above. This timing method is therefore disadvantageous in power consumption.

In part (3) of FIG. 11, information in the scenario table ZA102 is delayed and stabilized with a flipflop for timing adjustment in the information player ZA105 in advance at time t3, according to the sync information from the microprocessor ZA101, and then supplied to the microprocessor ZA101.

In the above timing method, also, transition due to signal delay occurs, but this is essentially only when transition in signal value occurs. For example, in the boundary between times t4 and t5, no wasteful power consumption due to signal transition occurs unlike the case of part (2) of FIG. 11.

As described above, the flipflops in the information recorder ZA103 and the information player ZA105 of the scenario control section ZA101 are placed not simply for timing adjustment but to play a very important role deliberately prepared to attain power reduction.

An effect of the present invention is to enable the advance information supply shown in part (3) of FIG. 11 described above.

Next, important operation concepts on recording/playing of scene information by the scenario control section ZA101 will be described.

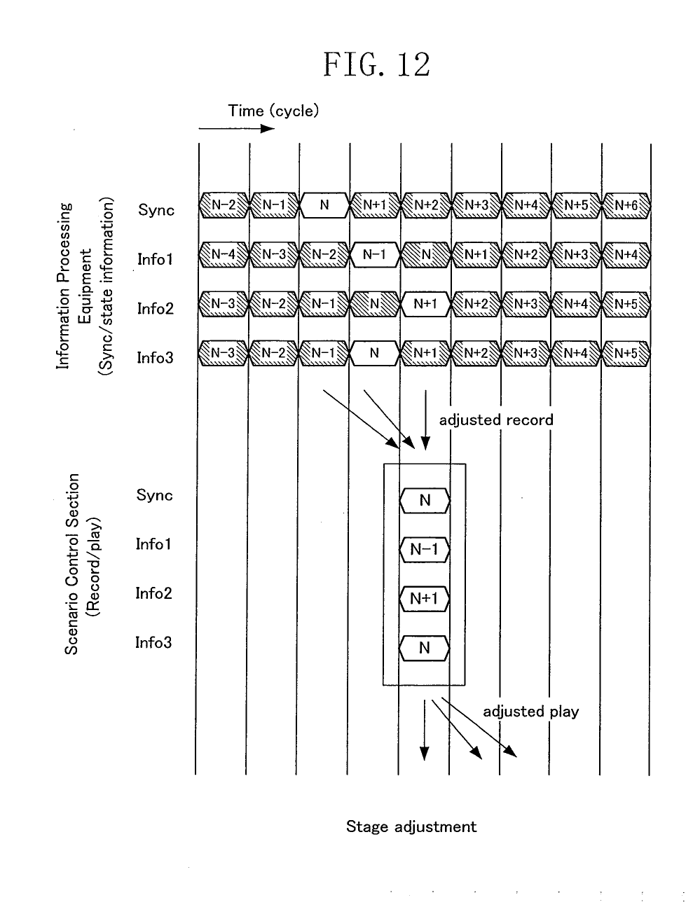

FIG. 12 shows timing adjustment between pipeline stages in the microprocessor ZA120 performed before the scene information ZA210 is recorded and played, as described before. With this adjustment, advance information supply, stable signal information supply and high-speed signal information supply can be achieved. In addition, as will be described later, wraparound information related to the head and tail of a loop can be recorded and played. Also, as a risky bit described later, conditional play control operation can be achieved.

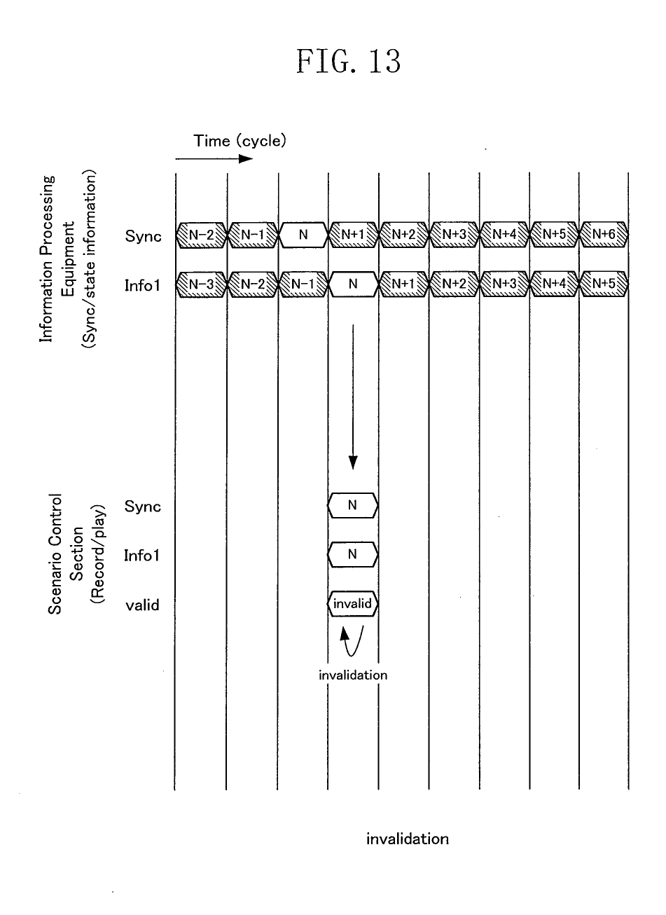

FIG. 13 shows a mechanism of invalidating recording of the scene information ZA210 in the scenario control section ZA201. With this invalidating means, the scene information ZA210 can be safely recorded and played, and malfunction of the information processing equipment can be easily suppressed. Further, with the selective recording means, effective information recording can be attained even when the number of recordable scenes is small.

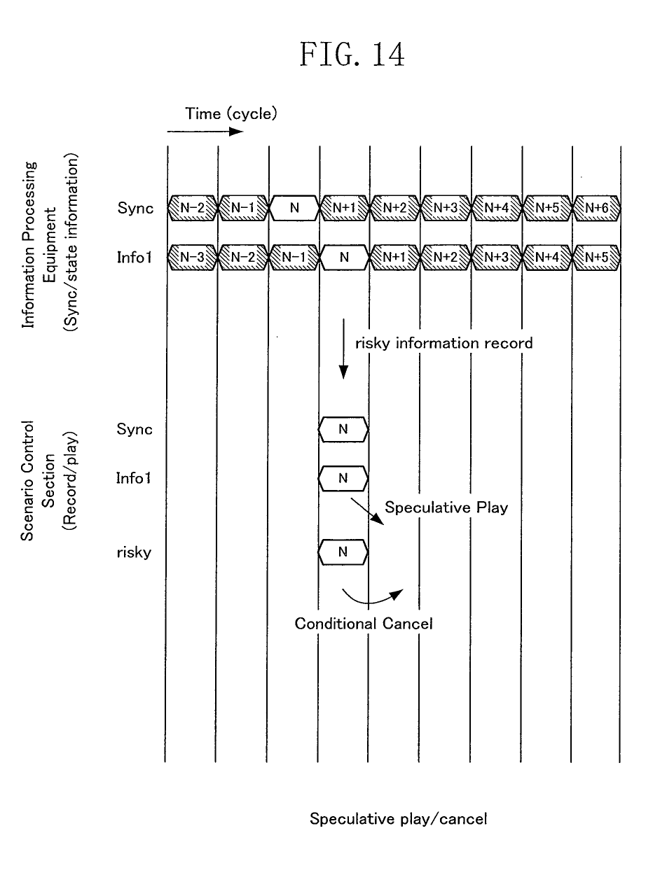

FIG. 14 shows speculative and conditional playing of the scene information ZA210 in the scenario control section ZA101. With the conditional execution function, the scene information ZA210 can be played more safely. Also, since the range of the object to be recorded and played can be widened, the performance can be more enhanced.

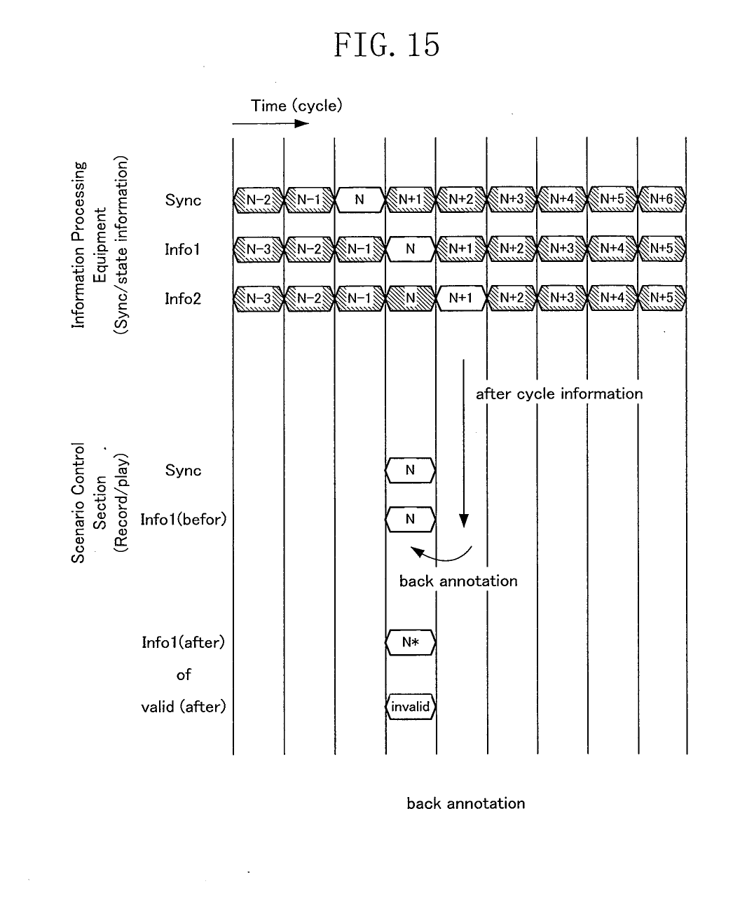

FIG. 15 shows correction and re-recording of information (back annotation) for already recorded scene information ZA210 in the scenario control section ZA101. With the back annotation, feedback of an already recorded entry can be made to add information for enhancement in performance to thereby provide effective play. Also, unnecessary scene information ZA210 can be invalidated with the back annotation, to ensure safe operation and also make effective use of the space of the scenario table. Naturally, flush operation abandoning all units of scene information can be implemented with the back annotation function.

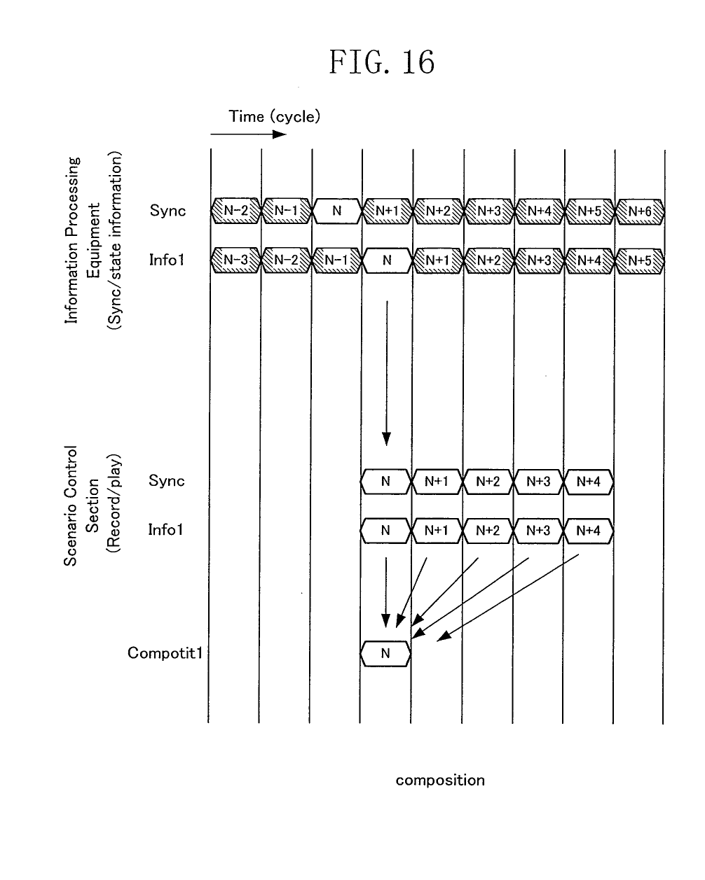

FIG. 16 shows composition in which representative information is given based on already recorded scene information ZA210. With the composition, effective use of the space of the scenario table can be made, and thus the object to be controlled can be increased in a wider range.

Next, an example of configuration adopting the information supply and control method by the scenario control section ZA101 and the microprocessor ZA120, in the state control device of the present invention, will be described.

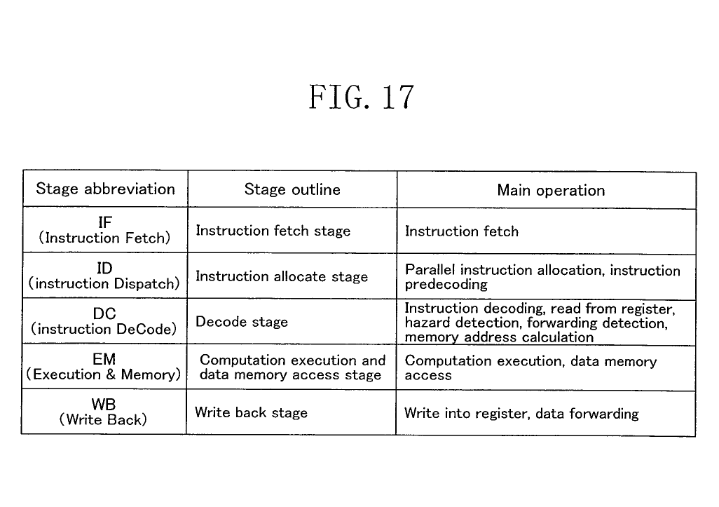

FIG. 17 schematically shows pipeline stages in the microprocessor ZA120 assumed in this embodiment.

FIG. 18 shows an exemplary bird's-eye configuration related to the information supply and control method by the scenario control section ZA101 and the microprocessor ZA120, in the state control device of the present invention.

Naturally, the pipeline configuration shown in FIGS. 17 and 18 is presented merely for description of an example of the present invention, and the applicable range of the present invention is not limited to the example shown in FIG. 17.

The sync information ZA110 is supplied from the microprocessor ZA120 to the scenario control section ZA101. In the scenario control section ZA101, scene information ZA210 corresponding to the supplied sync information ZA110 is retrieved from the scenario table ZA102.

Under control of the play controller ZA106, the information player ZA105 gives appropriate pipeline delay and performs information correction such as enable state reflection for control information ZA112 for controlling the microprocessor ZA120, obtained from the scene information ZA210 corresponding to the supplied sync information, and supplies the resultant control information ZA112 to the microprocessor ZA120 as state control information.

The control information ZA112 from the scenario control section ZA101 is supplied to function circuit groups at respective pipeline stages in the microprocessor. The function circuit groups perform various state changes such as startup, stop and selection controls, as described earlier with reference to FIG. 4, based on the supplied control information ZA112, to attain power reduction and enhancement in processing performance.

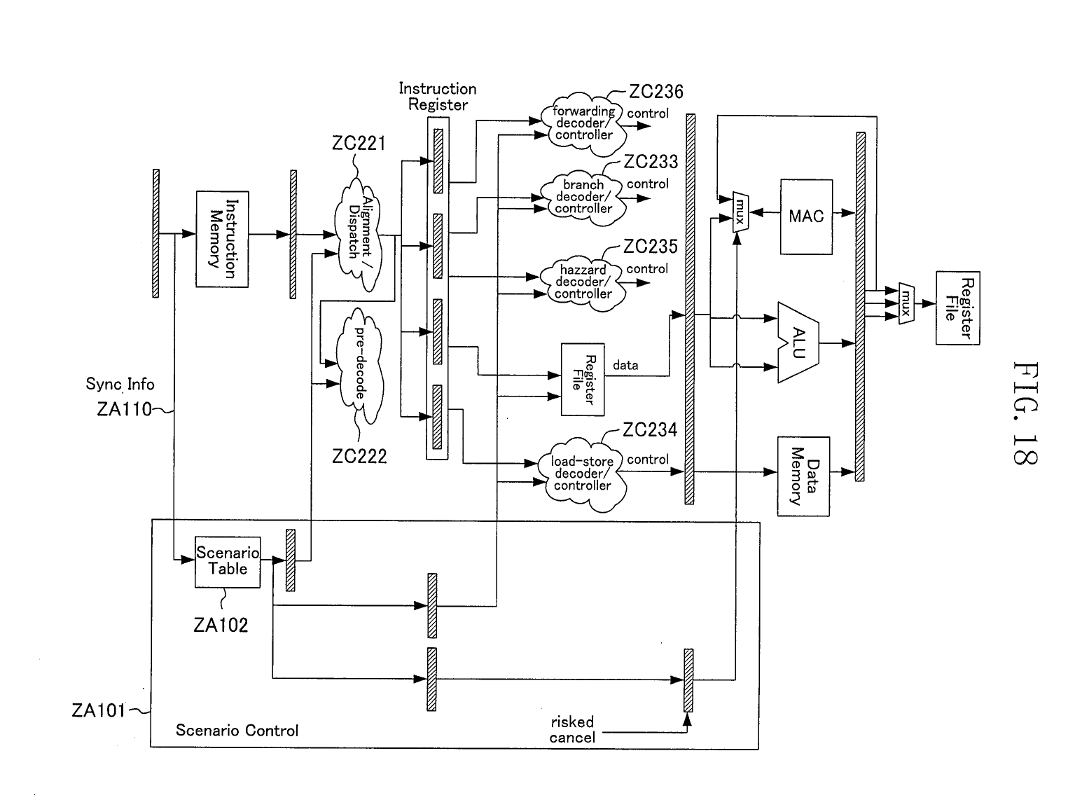

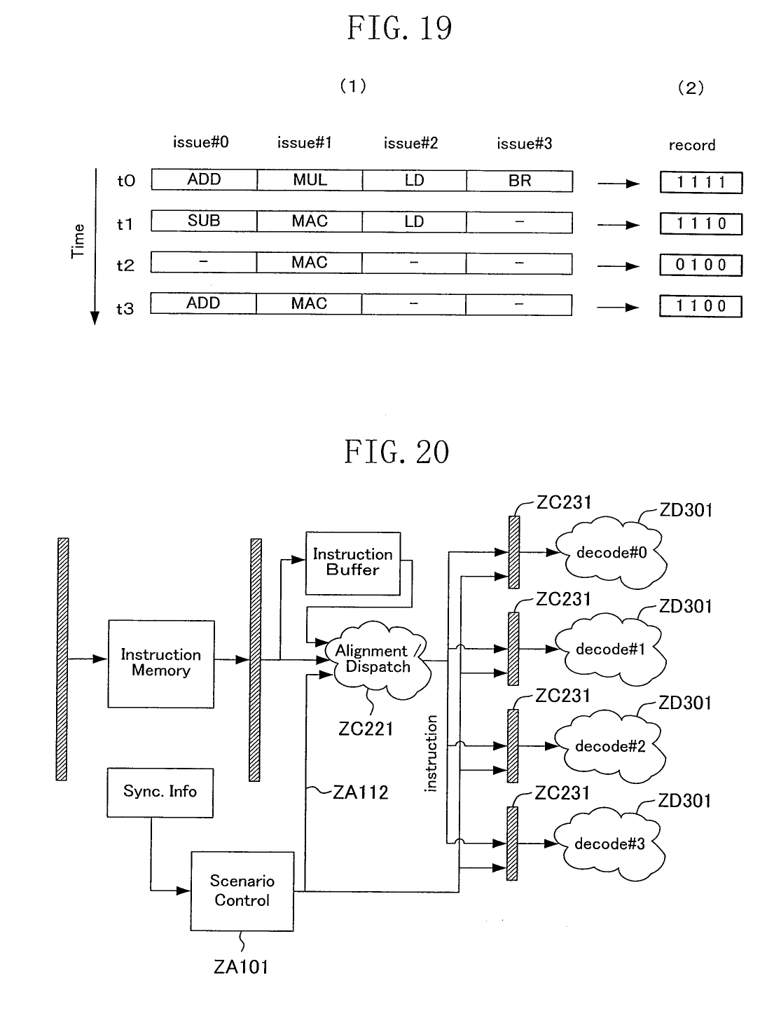

Hereinafter, an example of controlling instruction issuance of the microprocessor ZA120 by the state control method of the present invention will be described with reference to FIGS. 19 and 20.

Part (1) of FIG. 19 shows an instruction issue pattern in ID stage in the microprocessor ZA120. For example, at time t1, SUB instruction is allocated in the 0-th instruction issue pipeline, issue#0. Likewise, MAC instruction and LD instruction are respectively allocated in issue#1 and issue#2. The allocated instructions are decoded in DC stage. In part (2) of FIG. 19, the instruction issue pattern at each time is represented by a string of bits. The instruction issue pattern information at each time is recorded in the scenario table of the scenario control section ZA101.

FIG. 20 shows instruction issue and decode-related part of the microprocessor ZA120 in FIG. 19, together with the scenario control section.

An instruction allocation section ZC221 decodes information related to the instruction issue pattern from a supplied instruction group, sorts the instruction group appropriately and supplies the results to four instruction registers ZC231 as instructions to be issued. The instruction registers ZC231 receive the instructions to be issued at the start of the DC stage, and instruction decoders ZD301 decode the instructions.

According to the present invention, the instruction allocation section ZC221 can select and supply the received instruction group with the control information ZA112 sent from the scenario control section ZA101 without the necessity of decoding information related to the instruction issue pattern.

Also, the instruction registers ZC231 can suppress writing of instructions therein with FF update information supplied from the scenario control section ZA101 without the necessity of decoding information related to the instruction issue pattern.

As described above, since signal activation in the instruction allocation section ZC221 and the instruction registers ZC231 can be prevented, power reduction can be attained.

In particular, the ID stage, which is located upstream of the pipeline, is required to operate at high speed because the acquired instruction group must be decoded immediately. To speed up the operation, power consumption is generally increased.

According to the present invention, play control is made by acquiring in advance the instruction issue pattern and the dependence related to instruction issuance. Hence, power reduction is attained without reducing the operation speed. Instruction decode and pre-decode functions can also be the object to be controlled.

FIG. 18 shows a pre-decode circuit ZC222. In FIG. 18, a branch controller ZC233 and a memory controller ZC234 are shown as examples of instruction decoders.

The branch controller ZC233 executes state control based on control information from the scenario control section ZA101. For example, when the control information from the scenario control section ZA101 indicates stop of the branch controller ZC233, the branch controller ZC233 suppresses its circuit operation according to this stop instruction.

The scenario control section ZA101 may be configured to hold a decode pattern of the decoded results, but this is not necessarily required.

For example, effective state control will be attained by only recording that decoding itself of a control state as the object is unnecessary if this control state does not occur at high frequency. That is, effective power reduction is attained with a small-scale circuit implementation.

As for stop information, it is not necessarily required to produce stop information satisfying all conditions. The effect will be high by merely recording only a frequently occurring condition in the scenario control section.

For example, if about 80 percent satisfaction in terms of occurrence frequency is attained by presenting only about 20 percent of all conditions for matching, it is not necessarily required to produce a logic requesting 100 percent condition satisfaction from the standpoint of investment performance.

The above also applies to other circuit functions. That is, it is not necessary to record complete control information for the relevant cycle in the scenario control section ZA101.

Not only decoding of a single instruction, but also control related to linkage between instructions can be the object for the control by the scenario control section ZA101.

In FIG. 18, a data-dependent hazard detect controller ZC235 and a data forwarding controller ZC236 are shown as examples. A forwarding pattern and a hazard occurrence pattern in each cycle may be recorded. However, as in the case of the decoders described above, it is effective to record that no forwarding or hazard will occur in the scenario control section ZA101 as scene information if the occurrence frequency of such a state is low.

In the case described above, the circuit operation of the hazard controller ZC235 and the forwarding controller ZC236 can be suppressed in most cycles with the stop control from the scenario control section ZA101.

If hazard detection and forwarding control are necessary, the stop control is invalidated based on the scene information in the scenario control section ZA101. Thus, correct control operation can be executed with the hazard controller ZC235 and the forwarding controller ZC236.

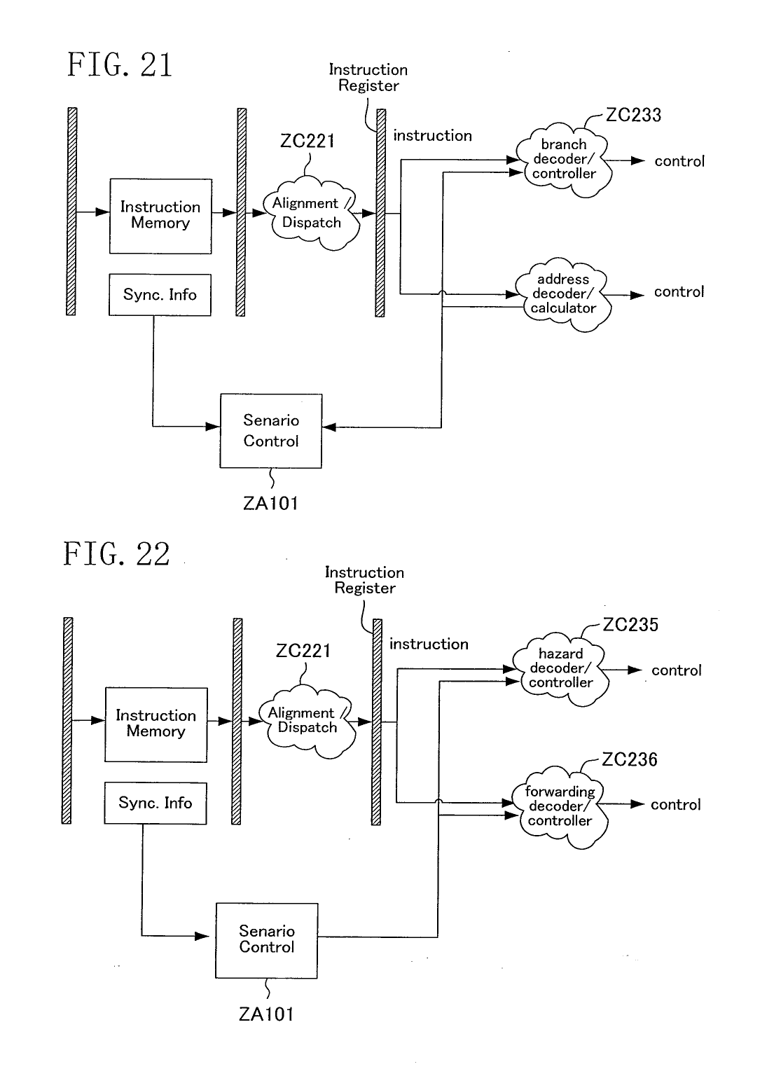

FIG. 21 shows an example of state control for branch control and address calculation related to data memory access, in a microprocessor provided with the state control device of Embodiment 1.

FIG. 22 shows an example of state control for data hazard control and data forwarding control, in a microprocessor provided with the state control device of Embodiment 1.

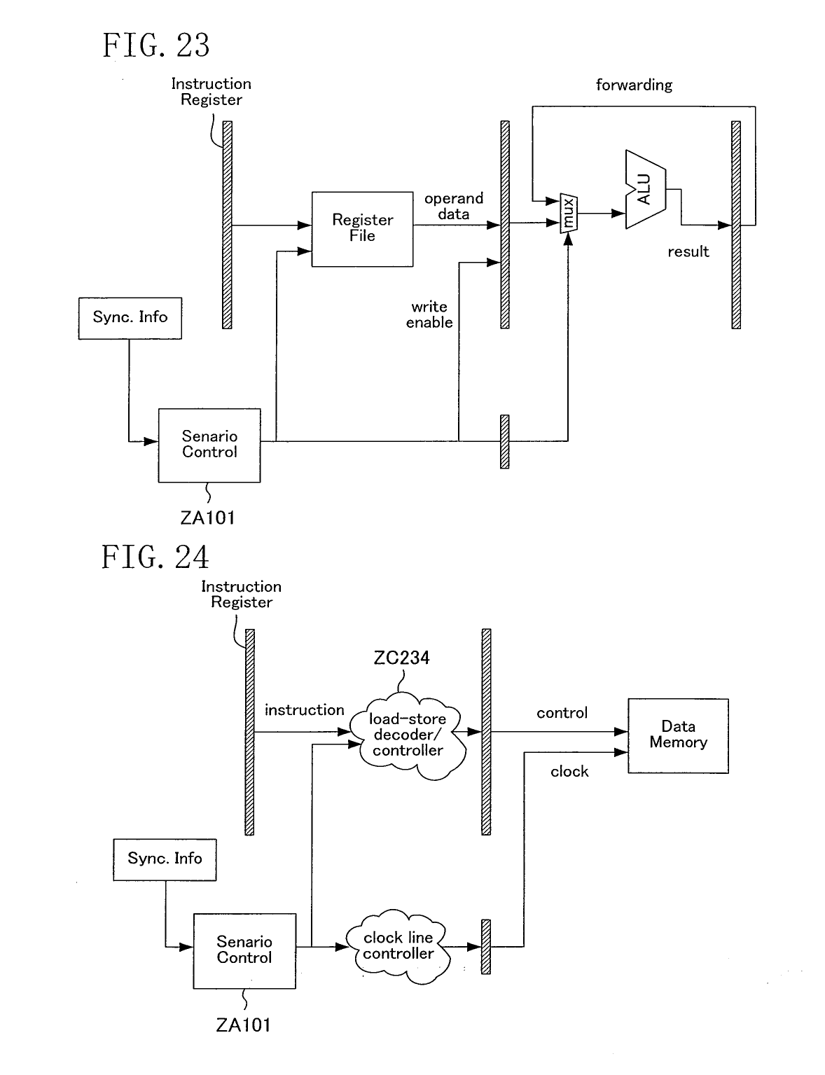

FIG. 23 shows an example of state control for data flow control of data forwarding in a microprocessor provided with the state control device of Embodiment 1.

FIG. 24 shows an example of state control for data memory access in a microprocessor provided with the state control device of Embodiment 1.

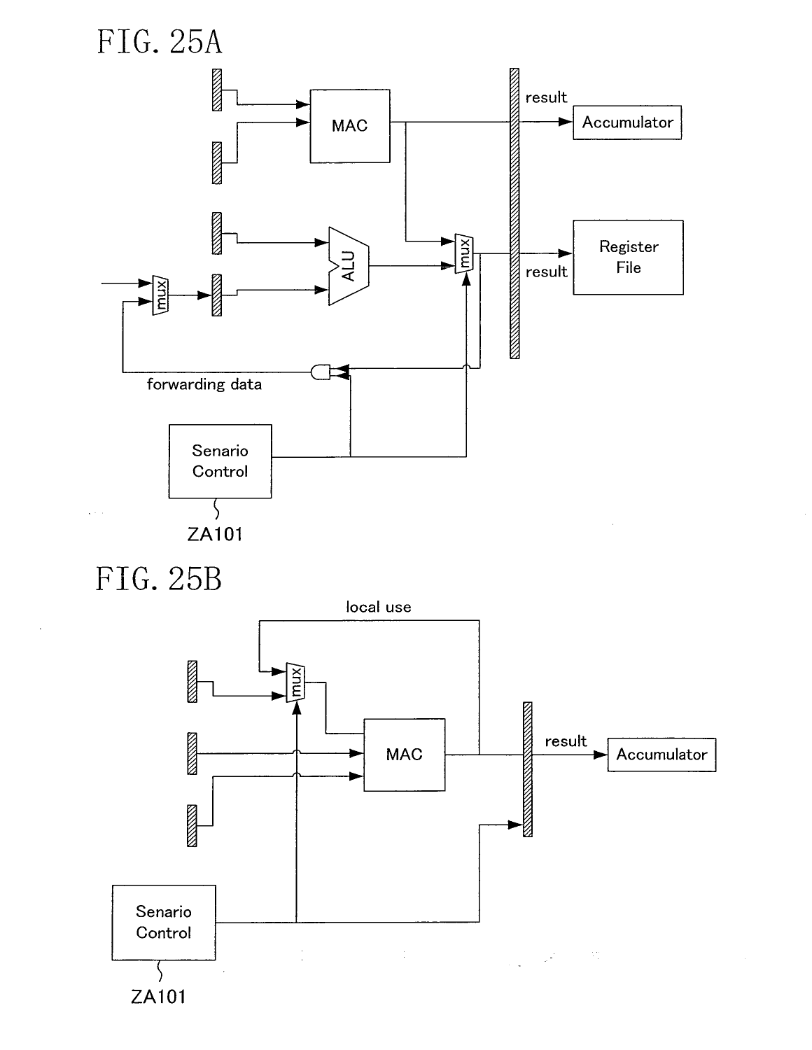

FIG. 25A shows an example of state control for default/path selection in a microprocessor provided with the state control device of Embodiment 1.

FIG. 25B shows an example of state control for computation localization in a microprocessor provided with the state control device of Embodiment 1.

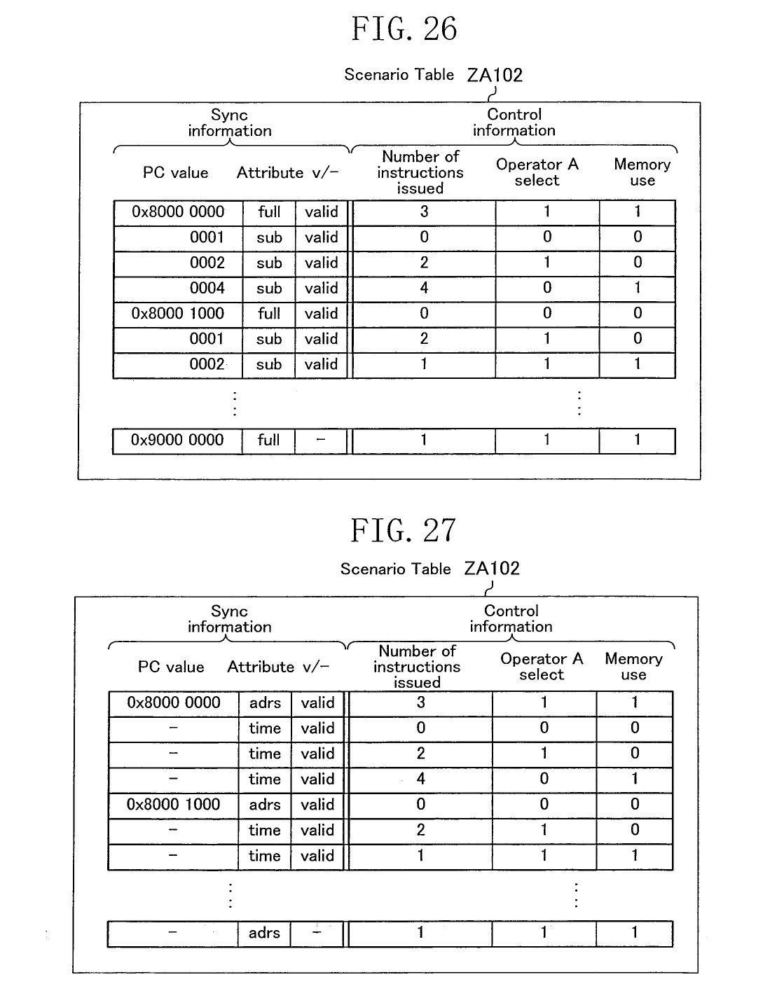

Next, with reference to FIGS. 26 to 28, examples of logical layouts of the scenario table ZA102 will be described.

FIG. 26 shows a specific example of the generalized scenario table ZA102 shown in FIG. 6, in which the sync information includes a trigger information field (PC value) for storing basic sync information, an attribute field for storing the type of synchronization of the sync information, and a valid field (v/-) indicating whether or not scene information stored is valid. This example is characterized by the trigger information field and the attribute field.

Although the program counter value (PC value) is used as the sync information in the above example, any of the sync information mentioned before may be used to provide a comparable configuration.

The attribute field indicates whether the value recorded in the trigger field covers the entire (full) or part (sub) of the sync information, that is, the program counter value.

In the example of FIG. 26, the sync information corresponding to the program counter value “80000000” covers the entire information as “80000000”, and thus the value of the attribute field is “full”.

On the contrary, the sync information corresponding to address “80000001” is recorded as lower-order part information “0001”, and thus the value of the attribute field is “sub”.

In the above example, the scenario control section ZA101 is configured so that comparison of sync information as the starting point is made only for scene information of which the attribute field is “full”, for example. In this example, three scenes, “80000000”, “80001000” and “90000000” are subjected to sync comparison.

After matching of “full” information, only the scene information having “full” attribute that has matched in the comparison and scene information having “sub” information related to the above “full” attribute are subjected to sync comparison.

Accordingly, after the sync matching of “80000000”, only scene information having lower-order bits of the program counter value of “0001”, “0002” and “0004” can be subjected to comparison, and thus the circuit scale and power consumption can be reduced.

In the above method, in which only part information of the program counter is compared, there arises the possibility that program counter values having the same lower-order bits but different in higher-order bits may be erroneously determined matching. To prevent this problem, branching may be detected, for example, to ensure that play control is executed only when the program counter value does not jump outside an assumed range. By adopting this method, an inexpensive state control device can be provided.

FIG. 27 shows an example also characterized by the attribute field. In this example, the attribute field has “adrs” attribute indicating that full matching is performed for the program counter as the sync information and “time” attribute indicating that comparison in cycle units is continued for synchronization after the scene information having “adrs” attribute has matched in sync comparison.

In the above example, as in the example of FIG. 26, comparison of sync information as the starting point is made for the scene information having “adrs” attribute. After the sync matching, the scene information having “time” attribute following the scene information that has matched is used for play control in each time cycle.

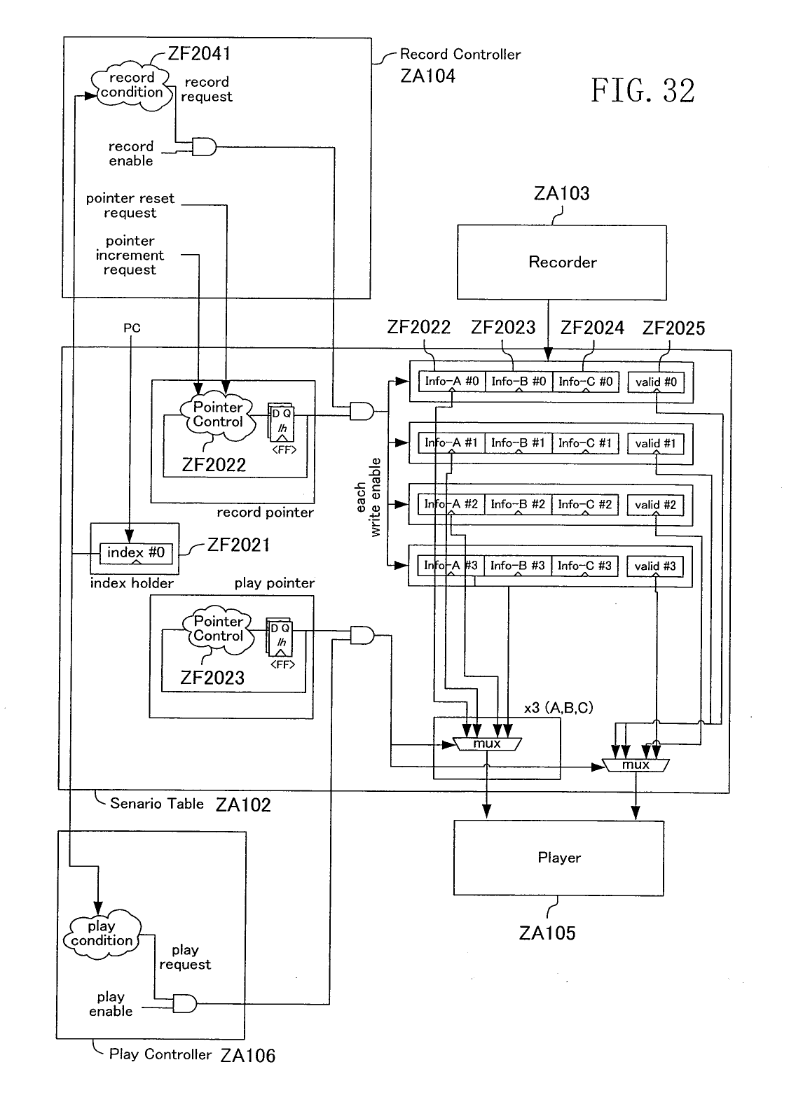

The illustrated table is an example of logical layout, as in the examples of scenario table layout described earlier. Physically, it is not required to adopt this layout. An exemplary hardware configuration for implementing this logical layout will be described later with reference to FIG. 32.

As another case of using the “time” attribute, considered is a method of playing next scene information every specific event occurrence, not every cycle. In either case, an inexpensive method for forming a scenario table with a small-scale hardware configuration can be provided.

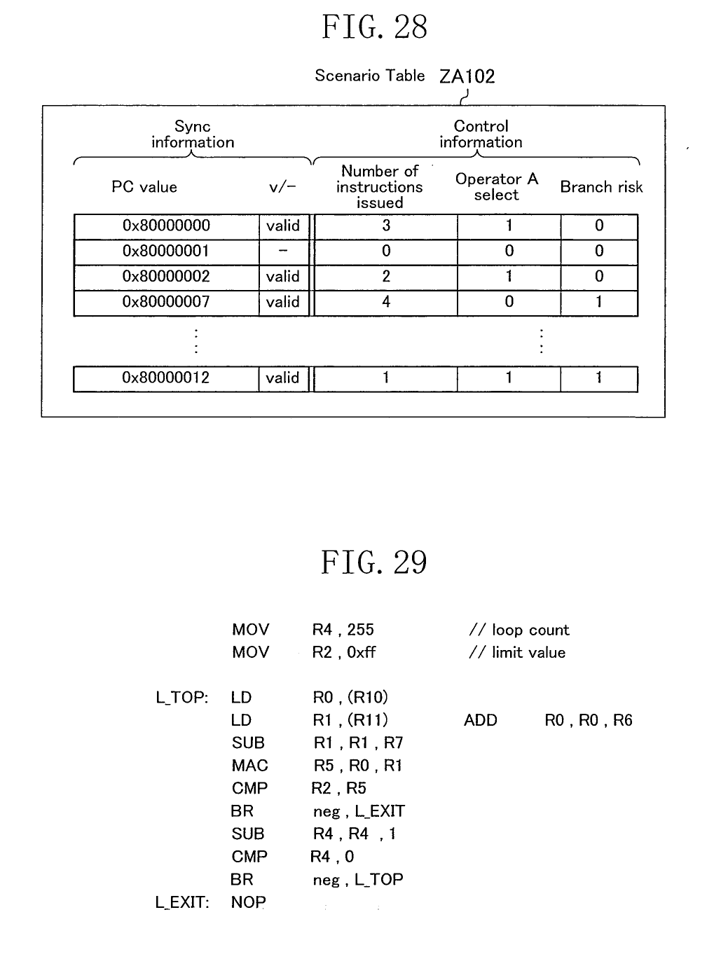

FIG. 28 shows an example of the generalized scenario table ZA102 shown in FIG. 6, in which the control information is composed of control information fields and a condition field indicating the type of the information. In this example, as the condition field, risk information (branch risk) on a conditional branch is stored. Operation of the state control device implementing this logical layout will be described later.

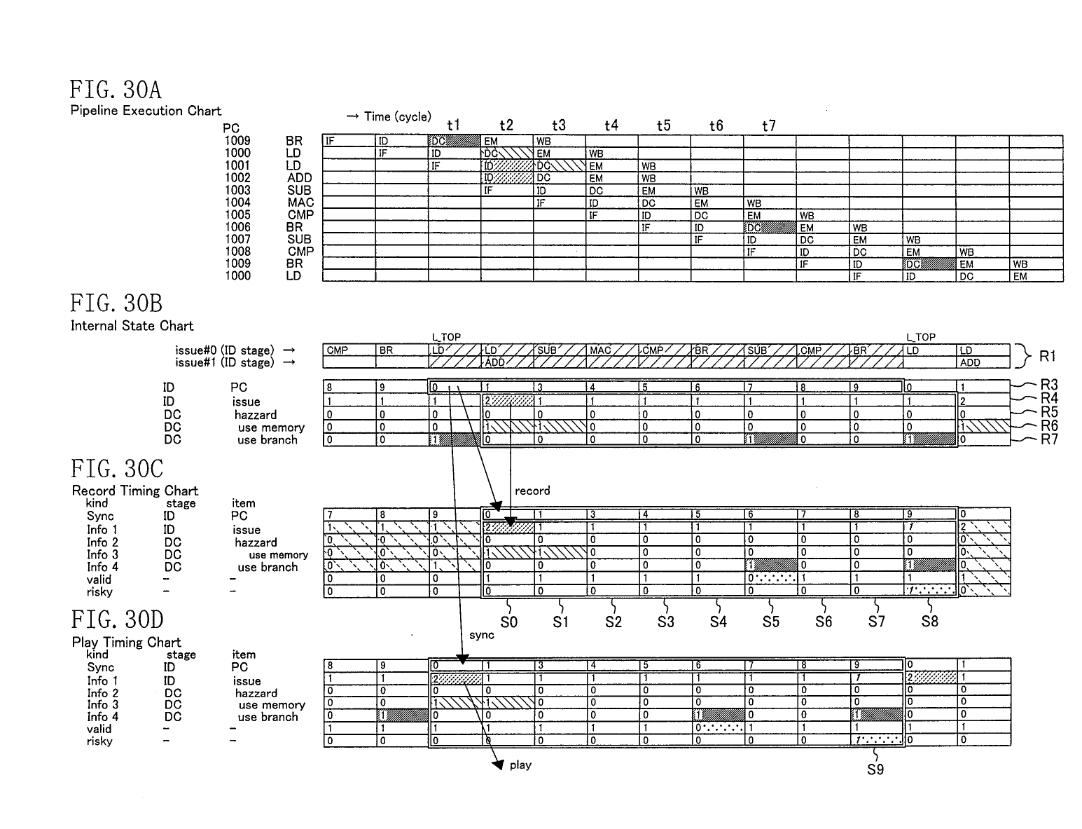

Referring to FIGS. 29 and 30A to 30D, the transition of the hardware internal state, and the details and timing of record and play information in the microprocessor ZA120 and the scenario control section ZA101 will be described.

FIG. 29 shows an instruction program used in the above example, in which an instruction string from LD instruction through BR instruction is repeated. Note that in this example, conditional branch (BR) instruction is used to give a loop structure and a conditional branch is also included in the loop.

FIG. 30A shows an example of operation timing of pipeline stages in respective time cycles at time-series execution of the instruction program (FIG. 29) in the microprocessor ZA120. For example, LD instruction in address 1000 is under execution of DC as a pipeline stage at time t2. In terms of the time, for example, at time t3, it is SUB instruction in address 1003 that is in the ID stage, that is, under instruction allocation.

FIG. 30B shows the internal states of resources in the microprocessor ZA120. For example, the rows of resource R1 represent the instruction allocation state in the ID stage in the microprocessor ZA120. For example, at time t2, LD instruction and ADD instruction are respectively allocated in issue #0 and issue #1 of the ID stage.

Likewise, resource R3 represents the state of the program counter in the ID stage, R4 represents the number of instructions issued in the ID stage, R5 represents the data hazard occurrence state in the DC stage, R6 represents occurrence or not of memory access in the DC stage, and R7 represents the state of occurrence or not of a branch instruction in the DC stage.

For example, the number of instructions issued R4 indicates issuance of two instructions at time t2. In this cycle, LD instruction and ADD instruction are issued. As for the resource R6 as memory access control, it is only at times t2 and t3 that processing related to memory access occurs. Likewise, in the resource R7 as branch control, it is at times t7 and t1 that branching may possibly occur.

In the illustrated example, no data hazard occurs in the loop. Hence, by using the state control device of the present invention, all control circuits related to detection of data hazard can be stopped in the loop.

Likewise, the memory access control in the DC stage is necessary only at times t2 and t3. Therefore, at the other times, memory access can be stopped in the steady state, and further decoding and control logic related to the memory access control can be stopped, by using the state control device of the present invention.

FIG. 30C shows the recorded contents of the scenario table ZA102, in which S0 to S8 represent respective scenes recorded in the scenario table ZA102. For example, the scene S0 includes “0” as sync information (Sync) and “2” indicating the number of instructions issued as information 1 (Info1).

In the above example, the record controller ZA103 performs sync adjustment of delaying the program counter value (PC) as the sync information by one cycle, and the delayed data is recorded in association with information of the microprocessor ZA102 obtained one cycle later. In the illustrated example, the value in the valid information field (valid) is “0” indicating that the scene information is invalid only in the scene S5.

The illustrated example represents, for the purpose of illustration, a case of invalidating scene information for avoiding possible control failure if a conditional execution instruction appears inside the repetition portion, not at the loop end. Such invalidation of a branch instruction is not necessarily required.

In the scene S8, loop head information in the next cycle is acquired and recorded as the information corresponding to the program counter value “9” as the sync information.

As described above, the information recorder ZA103 records information in the scenario table ZA102 in a wraparound manner after performing sync adjustment for the information even during execution in a loop. Therefore, state record and play control can be made in the loop without interruption.

In the illustrated example, the control information in the scenario table ZA102 includes a condition field, which is used as risky information field. The action of the risky information will be described later.

FIG. 30D shows play timing of scene information in the scenario table ZA102. For example, when the sync information (Sync) ZA110 of the microprocessor ZA120 is “0” at time t1, the scenario table ZA102 outputs “2” as the number of instructions issued (Info1) in the ID stage. The output value “2” as the number of instructions issued is delayed by one cycle by the information player ZA105 to be ready for immediate supply at the head of time t2.

The program counter value as the sync information was delay-adjusted by the information recorder ZA103. Therefore, the number of instructions issued information “2”, which will originally be obtained first at time 2 at which the program counter as the sync information is “1”, like the number of instructions issued information in FIG. 30B, can be obtained in the previous cycle.

Play control at the loop end will be described. In the illustrated example, the instruction at the end of the loop is a branch instruction involving condition determination. Accordingly, the next instruction at the loop end will be the LD instruction at the head of the loop if the condition is satisfied. If the condition is not satisfied, however, MOV instruction and ADD instruction after the loop will be executed.

If the number of instructions issued information “1” recorded in the information field 1 of the scenario table ZA102 is used when the condition is not satisfied, operation mismatch occurs. The number of instructions issued information should originally be “2” because the two instructions MOV and ADD are issued.

To avoid the above operation mismatch, the condition field is used. In the illustrated example, risky information as the condition field is “1” only in the scene S9 at the loop end. In this example, when the risky bit information supplied from the scenario control section ZA101 is “1”, the microprocessor does not use the control information ZA112 supplied from the scenario control section ZA101 based on the condition determination result of the microprocessor.

By adopting the method described above, the state control is continuously performed in the loop as long as the branch condition is satisfied. When the next instruction after the final iteration of the loop is to be executed, the control with the scenario control section ZA101 is suppressed, to enable safe execution of the circuit operation.

If there is the possibility of occurrence of an exceptional event that won't be recovered even with the conditional field, a re-executable interrupt/exceptional request may be generated to permit re-execution under a safe operation condition.

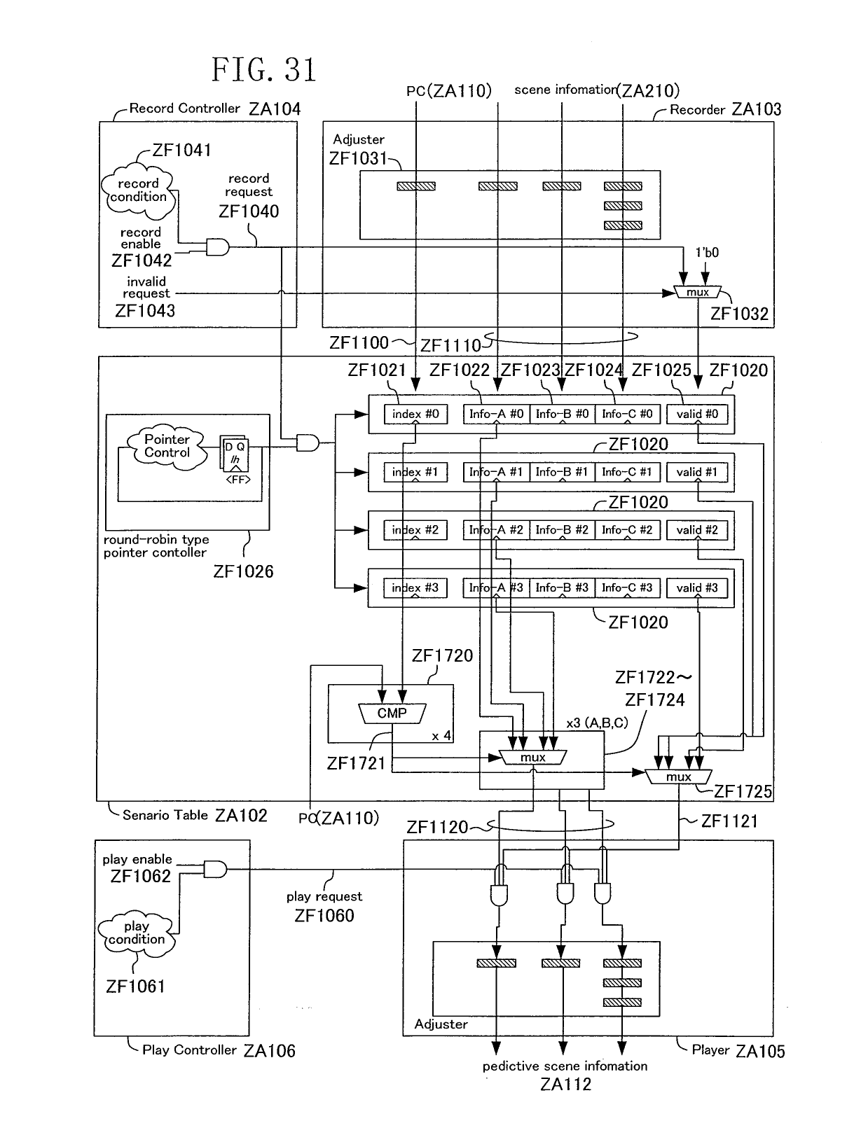

Next, referring to FIGS. 31 and 32, an exemplary hardware configuration of the scenario control section ZA102 will be described.

FIG. 31 shows an example of detailed configuration of the scenario control section ZA101 in FIG. 1. The logical layout of the scenario table ZA102 is the same as that shown in FIG. 7. The example of the configuration and operation of the scenario control section ZA101 will be described.

The sync information ZA110 and the state information ZA210 output from the microprocessor ZA120 are received by the information recorder ZA103. In the information recorder ZA103, the sync information ZA110 and the state information ZA210 are stage-related timing-adjusted by a record timing adjuster ZF1031 depending on the details of the sync information ZA110 and the state information ZA210, and then output to the scenario table ZA102 as processed sync information ZF1100 and processed state information ZF1110. Although not shown in the illustrated example, the information recorder ZA103 may naturally perform information processing with logical operation such as encoding and decoding, in addition to the timing adjustment, to facilitate subsequent play/supply of information.

The scenario table ZA102 includes a plurality of scene memories ZF1020. In the illustrated example, one scene memory ZF1020 is essentially composed of a sync information memory unit ZF1021 for recording the processed sync information ZF1100, state information memory units ZF1022 to ZF1024 for recording the processed state information ZF1110 and a valid information memory unit ZF1025 for holding information indicating whether or not recording of each scene is valid. In the illustrated example, for simplification of the description, the scenario table is shown as storing a total of four sets of scene information ZA210 each composed of the sync information and the state information. In other words, four states (scenes) of the microprocessor ZA120 can be stored and controlled.

In the illustrated example, in which one of the four scene memories ZF1020 information output from the information recorder ZA103 should be recorded is controlled with a round-robin type pointer controller ZF1026. The pointer controller ZF1026 points to one of the four scene memories ZF1020 sequentially as the target of recording. Although not shown in FIG. 31, the control is made using a record request and valid information. Although the control is made in the scenario table ZA102 in the illustrated example, it may otherwise be made to the scenario table ZA102 via the information recorder ZA103. The illustrated pointer controller ZF1026 is configured to permit overlap recording of the sync information for simplification. Naturally, more complicate recording control may be performed for the sync information, as in a tag memory configuration of a general cache system. Herein, however, to implement the device easily, output selection is made in a priority encoder style (not explicitly shown in FIG. 31).

As for the timing of recording, information is written into the scene memory ZF1020 pointed to by the pointer controller ZF1026 upon occurrence of a record request for the scenario table ZA102 given with a record request signal ZF1040 generated by the record controller ZA104. For simplification of description, a FF for timing adjustment of the record request signal ZF1040 is omitted in FIG. 31.

In the record controller ZA104, the record request signal ZF1040 is generated based on the output of a record condition determiner ZF1041 and a record enable signal ZF1042. The record enable signal ZF1042 may be a signal supplied from a control register provided in the microprocessor ZA120. Naturally, this signal may be omitted depending on the configuration.

The record condition determiner ZF1041, which will be described later, determines whether or not the relevant cycle in the operation of the microprocessor ZA120 satisfies a condition, which can be any of various conditions, for being the object for recording. If determining satisfying, the record condition determiner ZF1041 supplies a condition satisfy signal.

Recording of the valid information in the scene information ZA210 will be described.

In the illustrated example, the valid information indicating whether or not information held in the scene memory ZF1020 is valid is recorded in the valid information memory unit ZF1025 based on the record request signal ZF1040. The valid information is produced by a valid information generator ZF1032. In the illustrated example, the state value of the record request signal ZF1040 is supplied to the valid information memory unit ZF1025 as long as an invalid request signal ZF1043 output from the record controller ZA104 does not indicate an invalid state (redundant configuration).

With the invalid request signal ZF1043, recording into the valid information memory unit ZF1025 can be controlled for each scene. Although not shown in FIG. 31, control of invalidating the contents of a plurality of, or all of, the valid information memory units ZF1025 in the scenario table ZA102 is also necessary (not illustrated as the control is simple). This is because invalidation of all units of scene information is necessary at least at resetting.

Also, a plurality of, or all of, units of valid information may be invalidated (flushed) in such cases that information must be discarded due to occurrence of an exceptional event in an operation state of the microprocessor ZA120 causing discrepancy in the contents of the scenario table ZA102 and that it has become obvious that the recorded contents will not be used for play. With such invalidation, the state control can be performed by the scenario control section efficiently without discrepancy.

In information play operation, four sync information comparators ZF1720 of the scenario table ZA102 respectively compare sync information output from the four sync information memory units ZF1021 with the sync information ZA110 from the microprocessor ZA120, and output the results as comparison signals ZF1721.

Multiplexers ZF1722 to ZF1724 respectively select the output from the state information memory unit, among the four state information memory units ZF1022, corresponding to the sync information matching as the comparison result, and output the results to the information player ZA105 as a pre-processed control signal group ZF1120.

Likewise, a multiplexer ZF1725 selects a valid ID signal corresponding to the matching sync information from the four valid information memory units ZF1025, and outputs the result to the information player ZA105 as a selected valid signal ZF1121.

The information player ZA105 performs validity logic processing (AND operation in the illustrated example) for the pre-processing control signal group ZF1120 output from the scenario table ZA102 using the same pre-processing control signal group ZF1120 and a play request signal ZF1060 output from the play controller ZA106, performs given timing adjustment for the results, and outputs the adjusted results to the microprocessor ZA120 as the control information ZA112.

In the play controller ZA106, the play request signal ZF1060 is produced based on the output of a play condition determiner ZF1061 and a play enable signal ZF1062. Like the record enable signal ZF1042, the play enable signal ZF1062 may be a signal supplied from a control register provided in the microprocessor ZA120, for example. Naturally, this signal may be omitted depending on the configuration. The play condition determiner ZF1061 determines whether or not the relevant cycle in the operation of the microprocessor ZA120 satisfies a condition, which can be any of various conditions, for being the object for playing. If determining satisfying, the play condition determiner ZF1061 supplies a condition satisfy signal.

FIG. 32 shows another example of detailed configuration of the scenario control section ZA101 in FIG. 1. The logical layout of the scenario table ZA102 is the same as that shown in FIG. 27, although in this example the numbers of scenes corresponding to the attributes “adrs” and “time” are only one and three, respectively.

With the illustrated configuration, a state control device effective in actual software processing can be configured with comparatively small-scale hardware.

In the illustrated configuration, in which sync information is not individually recorded and held in the scenario table ZA102, neither the individual sync information memory units ZF1021 nor the sync information comparators ZF1720 in FIG. 31 are necessary. This enables reduction in hardware scale and power consumption.

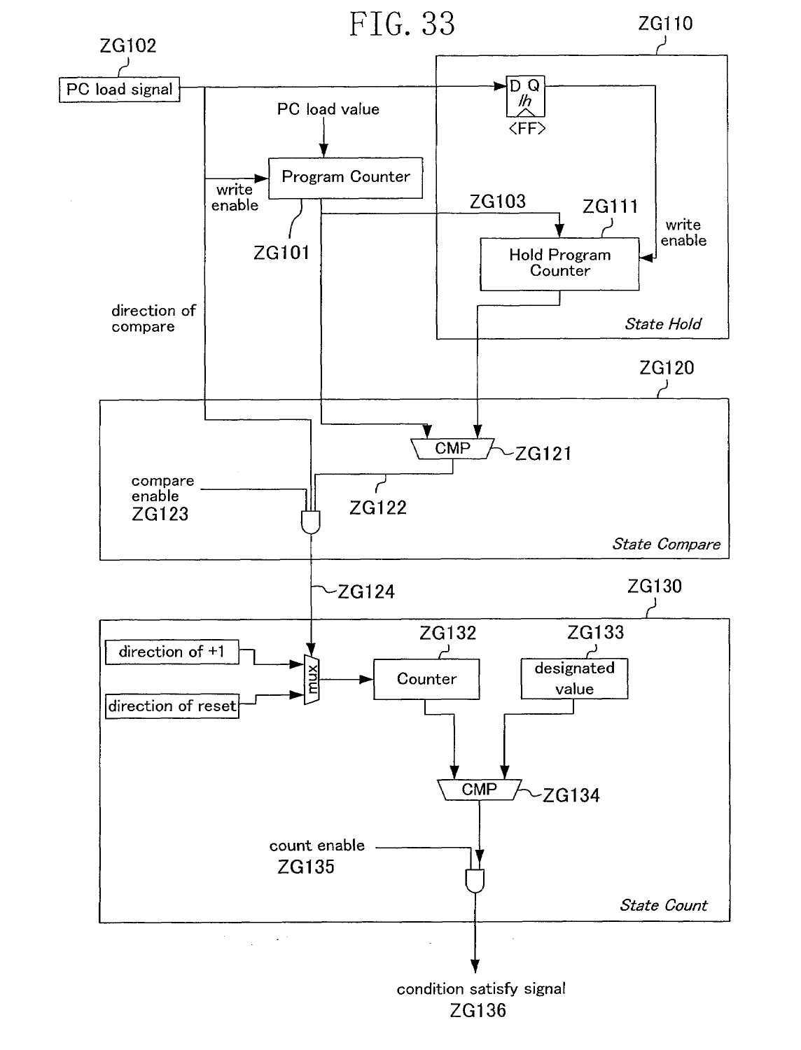

Sync information is representatively recorded in a sync information memory ZF2021 of the scenario table ZA102. The sync information memory ZF2021 is equivalent to a hold program counter ZG111 shown in FIG. 33 in record operation.

Likewise, a record condition determiner ZF2041 has the condition determining function of a state comparator ZG120 and a state counter ZG130 shown in FIG. 33. With the illustrated configuration, therefore, once the value in the sync information memory ZF2021 satisfies a record enable condition, scene information is recorded into the state information memory units ZF2022 to ZF2024 and the valid information memory unit ZF2025 in the subsequent cycles. Although not explicitly shown in FIG. 32, the record operation is terminated once a record pointer controller ZF2022 detects one round of the pointer.

In play operation, also, once play enable determination is made in the play controller ZA106 using the sync information memory ZF2021, a play pointer controller ZF2023 sequentially selects scene information for play, and outputs the control information ZA112 to the information player.

With the configuration described above, a scenario table with a small-scale hardware configuration can be obtained.

The configuration of the scenario control section of the present invention is not limited to those described above. Expansions and applications from the illustrated configurations, such as a method of searching an invalid scene and performing selective recording, and a method of detecting all recorded scenes and performing state transition, for the scenario table, can be easily inferred from analogy.

Next, selective operation control for recording and playing of state information in the state control device of the present invention will be described with reference to the relevant drawings.

In the easiest example of the state control device according to the present invention, control of recording and playing of state information may always be performed in each cycle. That is, in a simple example, control of recording and playing of state information is invariably performed after removal of reset for the microprocessor ZA120.

However, in the above simple method, recording is always performed even for an instruction string low in repetition occurrence frequency. In the worst case, an instruction string may continue to be always recorded but be discarded without being used for playing at all. This merely increases power consumption in vain, and thus is not preferred from the standpoint of power reduction.

Also, in the full-time recording method, important scene information may possibly overflow from the memory and thus be expelled one after the other. Therefore, to achieve a predetermined goal, it is necessary to provide a large circuit-scale memory capable of recording a large amount of scene information, and this will increase the cost and power consumption.

From the standpoint of power consumption, therefore, it is desired to reduce the number of times of recording and use recorded states for playing as often as possible. To achieve this, it is necessary to execute record and play operations with the scenario control section selectively for specific program portions.

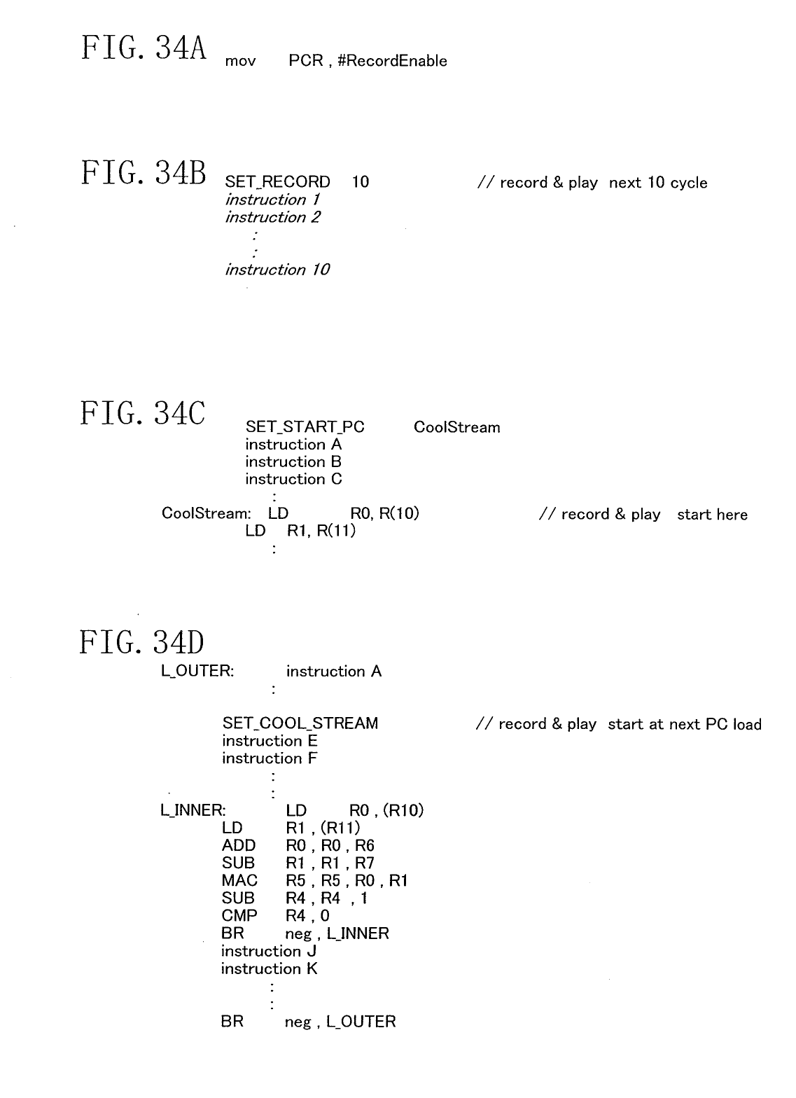

A first technique for the above is as shown in FIG. 34A in which enable information for enabling recording and playing is set for a control register (PCR in the illustrated example) of the microprocessor. The record enable signal ZF1042 and the play enable signal ZF1062 in FIG. 31 described above are examples of using the signal from this register.

In the above technique, the setting for a control register must be made by a software developer, and this will place a heavy burden on the software developer. Also, resultant developed software will have no general versatility but depend on the implementation of a specific microprocessor. Even if the setting for a control register is automated by use of a compiler and the like minimizing the burden on the software developer, a problem related to degradation in performance will arise. That is, insertion of an instruction of setting for a control register in a program portion high in repetition frequency results in addition of an instruction cycle unnecessary for the execution of the program. This will degrade the processing performance. The instruction of setting for a control register may otherwise be executed in a step far before the program portion high in repetition frequency. In this case, however, the problem of overflowing of the memory described above will not be solved. It is therefore necessary to provide a method for appropriately directing start and termination of record and play operations for a program portion high in repetition frequency.

FIG. 34B shows a method to overcome the problem of overflowing of the memory, in which the program range to which record and play operations are applied is designated in cycle units by means of execution of a specific instruction (SET_RECORD instruction in the this example).

In the above example, the processor state for ten cycles starting from the SET_RECORD instruction is determined as the object to be controlled by the state control device of the present invention. Naturally, from analogy of this method, it will be easy to infer a method in which the number of cycles after which recording/playing is started is also designated using this instruction. For example, recording may be started after five cycles and the recording may continue until the end of 15 cycles. This can be easily implemented using a simple counter as the center in terms of circuits.

FIG. 34C shows another method in which the state of the sync information (program counter in this example) for start of recording/playing is designated.

In the illustrated example, the program counter value at which recording/playing should be started is designated with SET_START_PC instruction. Unlike the method of FIG. 34B, it is unnecessary to strictly designate the start and termination of the set instruction with the absolute number of cycles. Therefore, this method is safe against a deviation in cycle, and also is resistive against a change in software and can enhance maintainability. In addition, since execution of the set instruction can be directed far outside a multiple loop, for example, degradation in processing performance can be effectively suppressed. Naturally, from analogy of this method, it is easily inferred that termination of recording/playing can be designated in a similar manner.

FIG. 34D shows yet another method in which recording/playing is started when a specific condition is satisfied after a set instruction (SET_COOL_STREAM instruction in this example).

In the illustrated example, “detection of a load of the program counter” is given as the specific condition. The first load of the program counter after execution of the SET_COOL_STREAM instruction occurs by executing “BR neg, L_INNER” instruction. Hence, the L_INNER-labeled instruction, that is, the head of the loop can be automatically found. This is a very effective and inexpensive method for detecting a high-burden portion. That is, by this method, the innermost loop can be found automatically in many general software programs having no complicate branch structure. For software production, also, this method is a more versatile setting method without the necessity of directly or indirectly designating the start or termination portion of recording/playing, unlike the method of FIG. 34C.

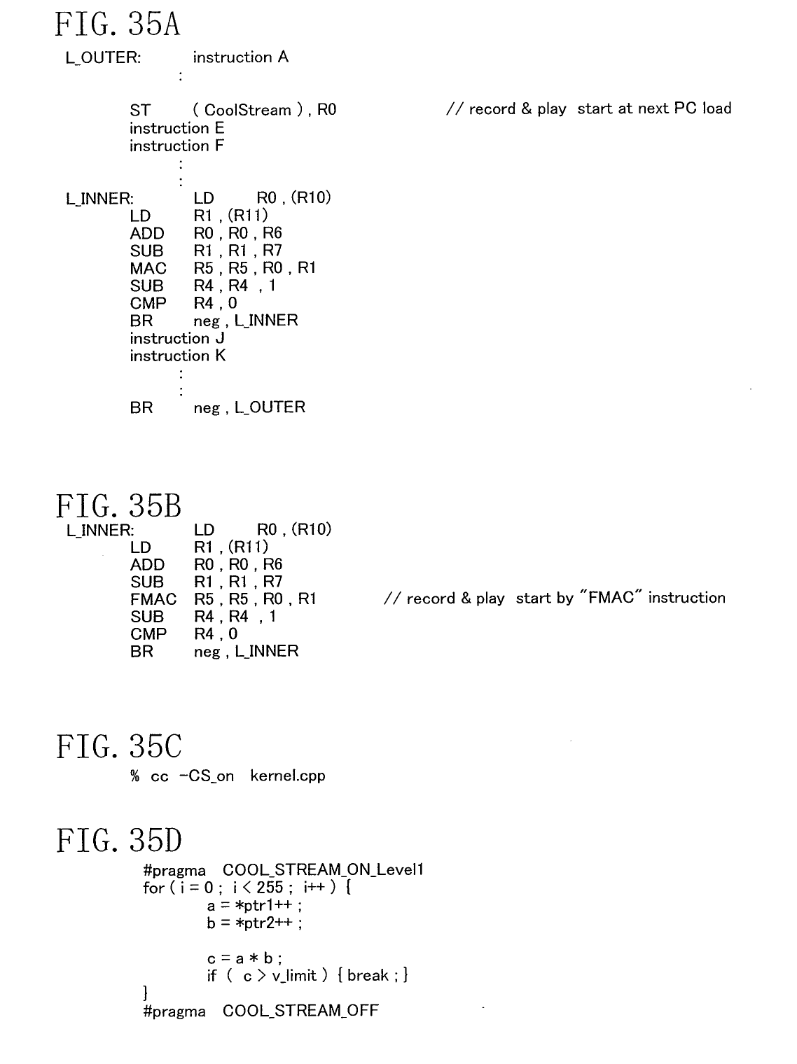

FIG. 35A shows an example in which operation equivalent to the SET_COOL_STREAM instruction in FIG. 34D is performed with a general instruction, not a dedicated instruction. Operation equivalent to the SET_COOL_STREAM instruction can be performed with write operation into an address-mapped control register as the starting point. It will be easily inferred that this applies to any of the methods of FIGS. 34A to 34D.

FIG. 35B shows an example in which occurrence of a specific instruction is used as an event of determination on whether or not recording/playing should be started and terminated. For example, a branch instruction, a loop-dedicated instruction itself and an instruction occurring in a high-burden portion with high possibility may be used as such an event, to attain effective transition determination. The method of FIG. 35B uses appearance of a fixed-point multiply-accumulate (FMAC) instruction as the determination condition to start recording/playing. Such FMAC instruction appears in a high-speed computation portion such as signal processing with high possibility. It is therefore reasonable to determine that execution of this instruction implies a high-burden portion.

Next, a method of simplifying the description of the set information by software shown in FIGS. 34A to 34D, 35A and 35B will be described.

FIG. 35C shows an example in which execution or not of enable control for state change is designated with a compile option of a compiler. In this example, a set instruction for state change is inserted in a source file “kernel.cpp”. When this option (-CS_on in the illustrated example) is designated, the compiler inserts the set instruction for executing state change shown in FIG. 34A, for example. With this method, the software developer can select execution or not of state control in compile module units without changing the source program, and this can enhance the productivity and general versatility of software. Naturally, the level may be given to the option in compiling to make the level of the state change control executed selectable.

FIG. 35D shows an example in which execution or not of enable control for state change is designated with a directive given into a source program. With this method, a control execution portion can be properly designated in the stage of development of a high-level language such as C language, without necessarily requiring describing directly in assembler-level software. In the illustrated example, the state control according to the present invention is executed for the for-loop with pragma directive of C language. The compiler inserts a set instruction of enable control for state change for minimizing degradation in performance, in the designated software portion. For example, by analyzing a loop structure, it is possible to insert a set instruction in a step preceding the target loop portion to thereby suppress degradation in processing performance.

Hereinafter, a method for starting or terminating record and play operation without advance execution of a set instruction by software will be described with reference to FIG. 33. FIG. 33 shows an example of the most effective method for starting record and play operation, in which a high-load state is detected automatically and upon detection automatic actuation leads to start of record and play operation. This method minimizes the burden on the software developer, reduces the cost, that is, reduces power consumption, minimizes the effect on the circuit operation speed and reduces the circuit scale, and yet can achieve a predetermined goal. In the following description, the program counter value is used as the object for the condition detection. Naturally, configurations using various events and conditions other than the program counter can also be provided.

A program counter ZG101 in the microprocessor ZA120 reads a new program counter value ZG103 when a PC load signal ZG102 for discontinuously updating the program counter is asserted. Although not illustrated, the program counter ZG101 also performs normal increment operation with the progress of the program.

In a state hold section ZG110, the program counter value obtained when the PC load signal ZG102 is asserted last time is held in the hold program counter ZG111.

Once the PC load signal ZG102 is newly asserted, a state comparator ZG121 in a state comparison section ZG120 compares the value of the program counter ZG101 with the value of the hold program counter ZG111, and asserts a counter match signal ZG122 when the two values match with each other.

In the state comparison section ZG120, also, OR among a compare enable signal ZG123 for enabling comparison, the PC load signal ZG102 and the counter match signal ZG122 is computed and output as a state match signal ZG124. The state match signal ZG124 is therefore a signal asserted when the current PC value matches with the last PC value under the conditions that the PC load signal is asserted and that the comparison is enabled.

The compare enable signal ZG123 can be omitted, and instead, bit information of a control register in the microprocessor ZA120 may be used.

In a state count section ZG130, a counter ZG132 increments its value with assertion of the state match signal ZG124. A count comparator ZG134 compares the value of counter ZG132 with the value of a count condition designate register ZG133. OR is computed between the comparison result and a count enable signal ZG135, and the result is output as a condition satisfy signal ZG136.

Naturally, in place of the count comparison, an initial-settable down counter may be used depending on the configuration.

As described above, in the illustrated example, once the same PC load is repeated a designated number of times, the condition satisfy signal ZG136 is asserted. The condition satisfy signal ZG136 may be used as the output signal of the record condition determiner ZF1041 in FIG. 31, for example, to thereby enable execution of record and play operation only when the condition of repeating the PC load a designated number of times is satisfied.

The above method is very effective in detection of a high-load software portion iterated frequently. For example, a branch control structure having ten or more loop times may be determined as the object to be controlled.

As another example, control may be made so that the first iteration of a loop is bypassed and the second iteration is subjected to recording. With this control, information effective in circuit operation can be recorded even for prolog remove description in a software pipeline structure made with a conditional execution function such as a predicate function.

The method of FIG. 34D, which is a versatile technique, can be combined with the configuration of FIG. 33.

Although the method for starting and terminating record and play operation using the program counter was described with reference to FIG. 34D, an internal state other than the program counter can also be used. Start and termination of record and play operation can also be determined using program ID for identifying the software executed in the microprocessor ZA120 and a change of the privilege level and the value thereof as the starting point. With use of such information, only specific program ID, for example, can be used as the object for the state control according to the present invention, and this is effective both in performance and in safety of software design.

If the microprocessor has a dedicated loop instruction of forming a loop structure, the loop iteration value may be directly used as the object for transition. Otherwise, an address for access to a data memory and the access interval may be used as the object for determination, to serve as the condition for transition of the operation state.

In another example, detection of a specific event may be used as the object for determination. For example, execution of N times of DMA completion interrupt may be used as the condition for transition of the operation state. Using such a condition, it is also possible to predict that the program has entered a high-load portion.

Hereinafter, applications of the present invention to equipment other than the microprocessor will be described.

For example, as one method, software processing is statically allocated to a hardware structure to change the software to hardware. As another method, software processing is executed in dynamically reconfigurable hardware equipment with software mapping information. These are not limited to high-level synthesis techniques. In either method, there is a state resource equivalent to the program counter that is a basic factor used by conventional microprocessors to control the flow of software execution. For example, a state value in a sequencer and a simple counter can be a state source. With the state value and the counter, the internal state of hardware is determined substantially uniquely and the execution is controlled momentarily. Therefore, such a state value and counter value can be used as the sync information for the scenario control section.

The circuit structure as the object for control can be controlled appropriately according to the present invention in any of the equipment other than the microprocessor, as in the microprocessor described above.

The applicable range of the present invention is not limited to a single microprocessor. For example, the present invention is also applicable to a parallel processor configuration composed of a plurality of processors. Using PC values, program ID, operation modes and the like of the plurality of processors as the sync information, valid internal states in the state of the sync information are recorded, and the information can be played once the same sync state occurs. For example, a combination of program ID at which external memory access has scarcely occurred may be recorded, and the memory controller may be stopped at the time of subsequent condition matching, to thereby reduce power.

Any determination condition may be made rewritable, to be adaptive to various software portions. In general, even within one program, the characteristics of high-load portions such as repetition portions differ from one another with software portions. Therefore, to improve performance, it is effective to control these portions with a rewritable condition. The conditions described above can be made rewritable. For example, in the example of FIG. 33, the count condition designate register ZG133 may be made rewritable. In the example of FIG. 35B, the kind of the instruction used as the object for determination may be made rewritable.

As described above, by setting the transition condition depending on the portion and kind of the software processing, the state control according to the present invention can be executed with a higher frequency.

The transition technique of the operation state with the program counter value described above is applicable to start and termination of both record operation and play operation.

There is a method for detecting termination of play operation, in which whether or not the value of the sync information ZA110 falls outside the preset program counter value range is detected. For example, play operation can be stopped when the program counter value is detected to be outside a predetermined range determined using the load of the program counter as the starting point. With this method, it is detected that a loop as the object for the play control with the scenario control section ZA101 is no more executed, and the play operation is suppressed upon detection, to thereby reduce power, for example.

In another method, used as the play termination condition is the number of times of detection of play sync failure indicating that the sync information ZA110 and the sync information in the scenario table ZA102 fail to match with each other during play operation, or the interval between occurrences of play sync failure. With this method, play operation can be suppressed when play sync failure occurs consecutive N times, for example.

For example, assume a software program subjected to the control with the scenario control section ZA101, in which the number of cycles per iteration of a loop is ten cycles and the number of scenes recorded with the scenario control section ZA101 is ten scenes.

In the above example, if play sync failure is detected consecutive ten times, processing of the loop should have been terminated and a software portion other than the loop should be under execution with a high possibility. Therefore, in this case, by detecting play sync failure consecutive ten times and suppressing the play operation upon detection, power reduction can be effectively obtained.

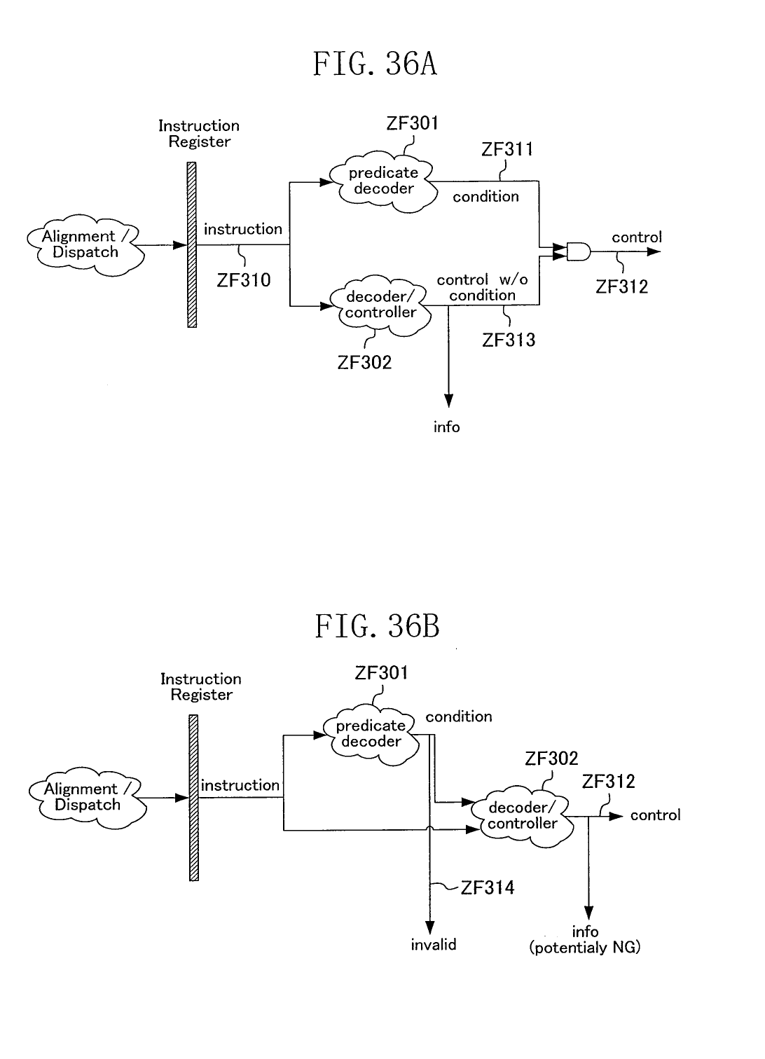

Next, selective recording in cycle units, in recording of the state information ZA111 from the microprocessor ZA120 into the scenario control section ZA101, will be described with reference to FIGS. 36A and 36B.

First, a conditional execution instruction will be described.

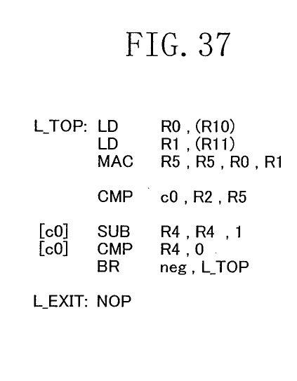

In general, a microprocessor has a function of executing a conditional execution instruction and a condition-designated instruction called predicate. The conditional execution function is important in particular in the recent trend of increased penalties due to increase of the number of pipeline stages and in processors high in the degree of parallelism of execution of instructions. FIG. 37 shows an example of conditional execution of instructions by a predicate method. In this example, SUB instruction and CMP instruction are valid only when “c0” is satisfied.

FIG. 36A shows a configuration for control related to a conditional execution instruction in the microprocessor ZA120. A condition determiner ZF301 determines whether or not the condition for execution of an instruction is satisfied. A decoder ZF302 decodes the instruction and generates a control signal.

A control signal ZF312 for controlling function groups is generated based on a logical operation (AND in the illustrated example) between a condition determination signal ZF311 generated by the condition determiner ZF301 and a condition-free control signal ZF313 generated by the decoder ZF302 by decoding an instruction ZF310 and using a related control signal.

In the configuration described above, as the state information ZA111 corresponding to the sync information ZA110, the condition-free control signal ZF313, not the condition reflected control signal ZF312, must be supplied from the microprocessor ZA120 to the scenario control section ZA101.

The reason for the above is as follows. During recording of information into the scenario control section ZA101, if the condition determination at the execution of an instruction in the microprocessor ZA120 is false and this information is recorded, the control signal will be always invalid in the subsequent play operation, and this will cause a malfunction. For example, assume a memory access instruction that is invalidated only in the first iteration of a loop. Once a simple memory access control signal ZF312 in the first iteration of the loop is recorded, stop control will be always performed in the second and subsequent iterations of the loop judging that there is no memory access because the scenario control section ZA101 performs play control for the memory access control based on this recording.

FIG. 36B shows another configuration for control related to a conditional execution instruction in the microprocessor ZA120. In this configuration, in which the condition determiner ZF301 and the decoder ZF302 are connected in series, unlike the case of FIG. 36A described above, no signal equivalent to the condition-free control signal ZF313 is obtained. If the condition reflecting control signal ZF312 is used as the state signal ZA111 supplied to the scenario control section ZA101, the problem of causing a malfunction described above occurs. In this configuration, as a means for avoiding occurrence of a malfunction, correction is made with an invalid signal.

Specifically, as illustrated, to deal with the problem that the control signal ZF312 may possibly be wrong information, an invalid signal ZF314 is asserted and supplied to the scenario control section ZA120 to invalidate a risk that may occur in the state signal ZA111 output from the microprocessor ZA120.

The invalid signal ZF314 may be connected to the invalid request signal ZF1043 in the example of FIG. 31, for example, to invalidate the relevant scene information, and in this way wrong use of the information for play control can be prevented.

In consideration of the purport of the present invention, the configuration of FIG. 36A is preferred. However, the configuration of FIG. 36A is not necessarily obtained in its optimized form particularly in a circuit design technique using the recent logical synthesis. Therefore, the configuration of FIG. 36B is still effective for safe circuit operation although positive state control such as stop may not be attained in the relevant cycle.

As for handling of a flow control instruction such as a branch instruction, it is effective to use the function of the condition field of the scenario table described above.

The invalid signal ZF314 is also effective for cases other than the condition determination. For example, in a microprocessor, the invalid signal may be asserted in an exceptional state that rarely occurs, such as in the event of an instruction alignment failure that occurs when a predetermined instruction packet is not available in instruction fetch operation. With this invalid signal, recording of the processor state in the relevant cycle can be suppressed as being no steady scene state.

The invalid signal ZF314 may be asserted with an instruction and the processor state. For example, the invalid signal may be asserted in a cycle in which the state is less worth recording and low in priority, to suppress recording of the state into the scenario table ZA102, to thereby make effective use of the capacity of the scenario table ZA102 and suppress the control operation.

Specifically, for example, while recording is suppressed with the invalid signal ZF314 during execution of a simple transfer (MOV) instruction, priority is given to recording of a memory access instruction and a multiply-accumulate instruction having a large operation range.

As another example, recording of the number of instructions issued may be stopped when this number is the largest one because it is inefficient to record this largest number.

Another internal state of the microprocessor ZA120 may be determined to perform the invalidation control. For example, conditional control may be performed using program ID allocated to each software program executed in the microprocessor ZA120 as the internal state of the microprocessor ZA120.

Recent microprocessors can execute a plurality of software programs by switching among these programs momentarily. By performing invalidation control based on the program ID, only programs having specific program ID can be selectively subjected to the state control according to the present invention, among a group of programs executed in parallel in short time units in a time division manner, for example.

The scenario control section ZA101 may otherwise generate the invalid request signal ZF1043, not using the invalid signal ZF314 but by determining a state over a plurality of cycles by the scenario control section ZA101.

For example, when the state control device of the present invention is used for low power control, the low power control should most desirably be performed continuously over cycles. If the low power control occurs every other cycle, stop control may be performed, and in this case, circuit activation will occur every cycle. An effect may be obtained in terms of the power even in this case, but it is also possible to detect such a case and suppress the low power control.

Specifically, a state is observed over three cycles, and when it is found that the low power control for the state is “possible, impossible, possible” in the respective cycles, the valid information in the scene information in the head cycle is negated.

As described above, according to the present invention, back annotation (backward reflection) to scene information recorded in the past can also be made and is actually effective.

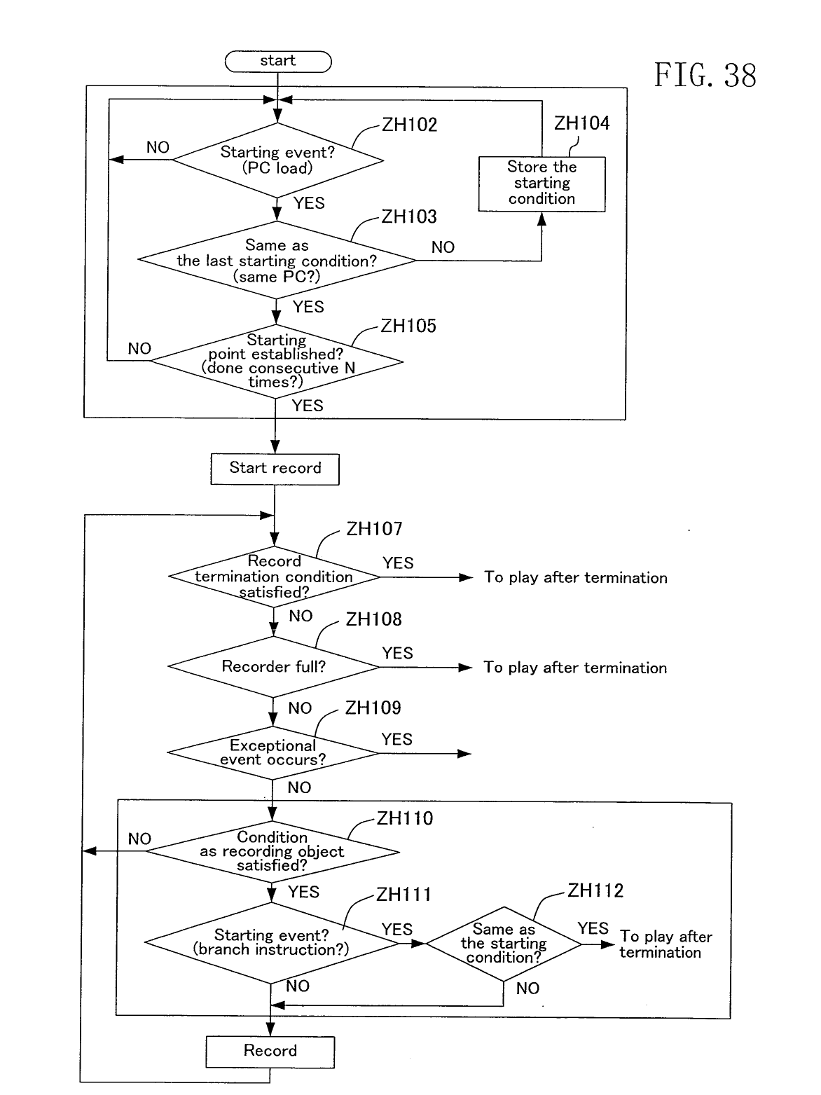

Hereinafter, an operation procedure of the record controller ZA104, in particular, of the scenario control section ZA101 will be described with reference to the flowchart of FIG. 38.

In condition determination ZH102, whether or not a condition as the starting point has occurred is determined. In the example of FIG. 33, this corresponds to occurrence of a load in the program counter.

In condition determination ZH103, whether or not the condition is the same as the last-recorded starting condition is determined. For example, the PC load is compared with the last program counter for matching, and, if not matching, the current program counter is recorded for next comparison in processing ZH104.

In condition determination ZH105, whether or not the number of times of matching of the starting point has reached a fixed number or an arbitrarily settable number is determined.

The processing ZH102, ZH103, ZH104 and ZH105 can be omitted in systems in which recording is always performed and systems in which start of recording is indicated explicitly.

In condition determination ZH107, whether or not a specific recording termination condition has been satisfied is determined. An example of such a condition is an explicitly designated number of times of recording.

In condition determination ZH108, whether or not the capacity of the scenario table ZA102 has been used up for recording is determined, and if YES, the recording state is terminated. For example, if the number of scenes recordable in the scenario table ZA102 is four and the software repetition portion as the object for control has six cycles, control is made for four cycles among the six cycles. This contributes to enhancement in performance compared with the case of performing no control at all. It is not necessarily requested to record the entire of a repetition portion such as a loop structure as the precondition for play. Also, it is determined whether or not continuation of the recording is useless due to an event such as occurrence of an interrupt and an exceptional condition. If YES, all of the recorded contents are discarded according to the construction of each example (ZH109).

In condition determination ZH110, whether or not the current state of the microprocessor ZA120 should be recorded is determined. For example, if it is determined that playing of the state is worthless or that playing is risky, the relevant cycle is withdrawn from being the object for recording.

In condition determination ZH111, whether or not a starting event has occurred is determined. For example, in the illustrated example, whether or not re-loading of the program counter has occurred is determined.

If a starting event has occurred, whether or not the current event is the same as the starting condition is determined in condition determination ZH112. If YES, which means that one iteration of the loop has been made, the recording is terminated and transition to play operation is made.

If the starting event is not the same as the starting condition, the recording is not necessarily terminated immediately. For example, in the case that the starting event is a load of the program counter, when the starting event occurs with a branch instruction, the branching is not necessarily to outside the loop structure.

When the event is branching to outside the loop structure, the possibility that the recorded contents may not be used for playing is high, but this will not cause a problem in operation. An exceptional operation having the possibility of causing a problem in operation is as described in relation to the condition determination ZH109.

In the illustrated example, a branch that does not match with the branch condition of the starting event will be a branch to inside the loop with high possibility. The reason is that no occurrence of jumping to outside the loop has been guaranteed in the procedure until the condition determination ZH105.

Thus, a conditional branch can be included in a repetition structure, for example.

In the illustrated example, the record state and the play state were separated from each other, and transition to the play state was assumed after termination of the recording. Naturally, a method in which recording and playing are executed simultaneously can also be provided.

In the condition determination ZH104, it can be made possible to store a plurality of starting conditions, to enable comparison with the plurality of conditions in the condition determination ZH103. With this setting, the state control device of the present invention will be able to perform state control for more complicate control structures.

For example, the present invention is applicable to the case that branching to inside a loop is frequently used in the loop and the case that control change often occurs in a loop that is not simple in structure but uses branching frequently and resultantly a given instruction portion is frequently executed.

### Embodiment 2

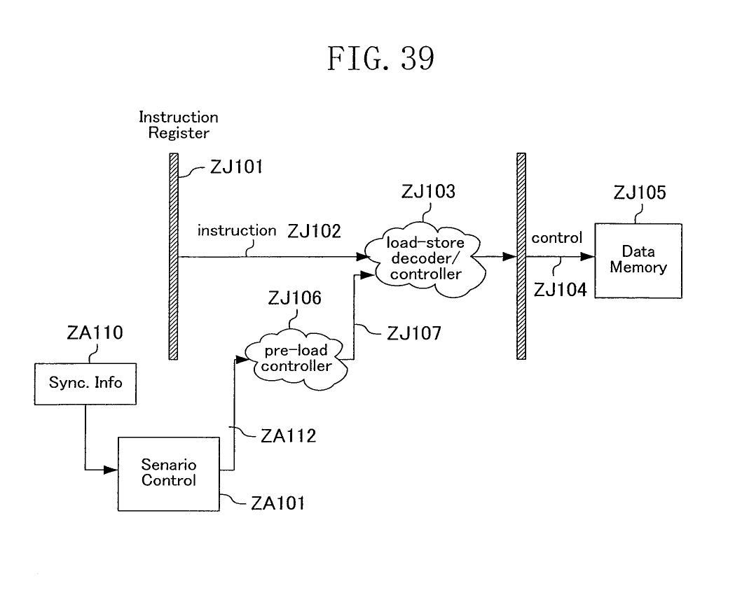

FIG. 39 is a view showing an example of configuration of a state control device for a microprocessor in Embodiment 2 of the present invention. The configuration of the scenario control section ZA101 is the same as that described in Embodiment 1.

In Embodiment 1, state changes of information processing equipment were mainly described as being made for power reduction. In this embodiment, description will be made mainly focusing on measures for enhancing processing performance.

In FIG. 39, the microprocessor ZA120 is controlled using the scenario control section ZA101 of the present invention. In the microprocessor ZA120, a memory access controller ZJ103 decodes an instruction ZJ102 supplied from an instruction register ZJ101, and performs load or store-access to a data memory ZJ105 with a control signal ZJ104.

The scenario control section ZA101 outputs the control signal ZA112 according to the sync information ZA110 from the microprocessor ZA120. Note that the program counter value is used as the sync information ZA110 in this example.

The control signal ZA112 is supplied to a pre-load controller ZJ106 that constitutes the state change controller ZA107. The pre-load controller ZJ106 outputs a pre-load request ZJ107 to the memory controller ZJ103 according to the control signal ZA112.

Upon receipt of the pre-load request ZJ107, the memory controller ZJ103 controls execution of loading of data to the data memory ZJ105.

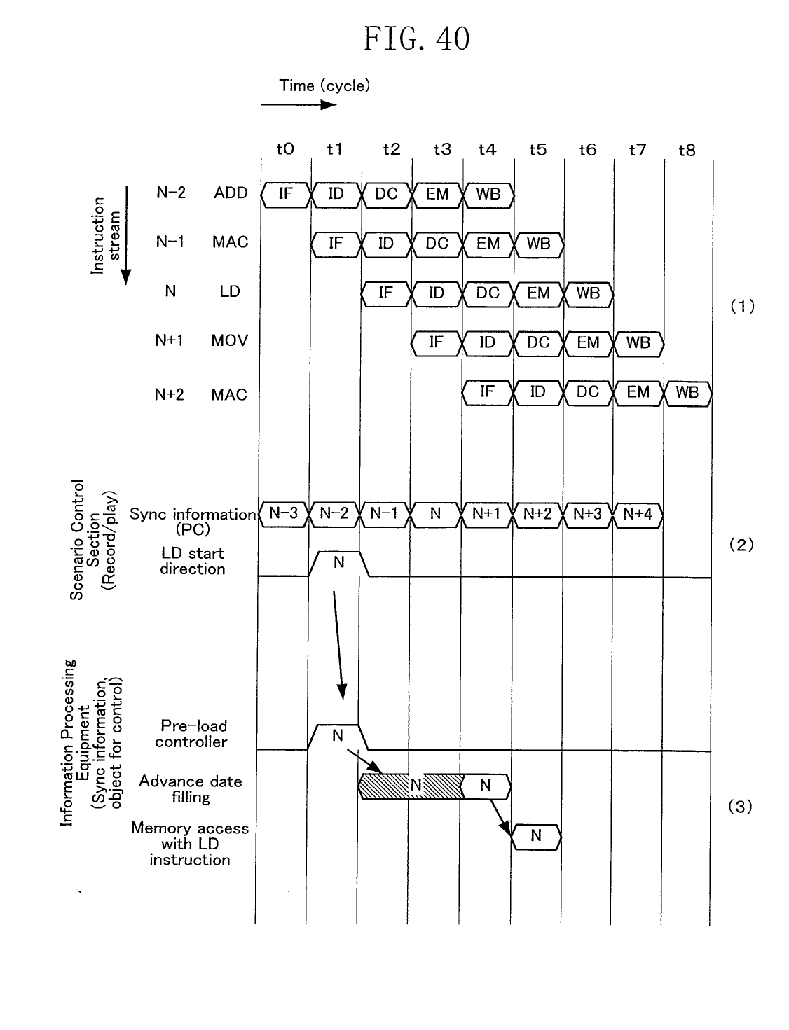

FIG. 40 is a timing chart showing the operation of the state control device for the microprocessor in Embodiment 2 of the present invention.

In part (1) of FIG. 40, the timing of execution of instructions is shown. In the illustrated example, LD instruction as the N-th instruction is started at time t2, and memory access is performed at time t5.

In part (2) of FIG. 40, the operation timing of the sync information and play control information in the scenario control device is shown. In the illustrated example, a direction related to the LD instruction is associated with the sync information in N−2 and is recorded as scene information. Hence, at time t1 at which the sync information ZA110 of the microprocessor ZA120 is in the state of N−2, the information related to the LD instruction is output as the control information ZA112.

In part (3) of FIG. 40, the timing of the control state in the microprocessor ZA120 is shown. The control signal related to the LD instruction output from the scenario control device ZA101 at time t1 is received by the pre-load controller ZJ106 at time t1. The memory controller ZJ103 starts memory access at time t2 with the pre-load request from the pre-load controller ZJ106, and the memory access is completed at time t4 in the illustrated example. Using this advance memory access mechanism, a data memory cache can be filled in advance, for example. In the illustrated example, memory access can be started in advance at time t2 three cycles before time t5 at which memory access with the original LD instruction starts. Moreover, at time t5, at which memory access with the LD instruction starts, the memory has been filled with data. Therefore, no miss-filling penalty with the LD instruction occurs, and thus no degradation in performance occurs. Naturally, since the increment of the address to be accessed can be calculated in advance separately, the memory access request may be made in an earlier cycle, and this enhances the performance.

As described above, by use of the state control method according to the present invention, advance state change control can be made for information processing equipment, and thus the processing performance can be enhanced.

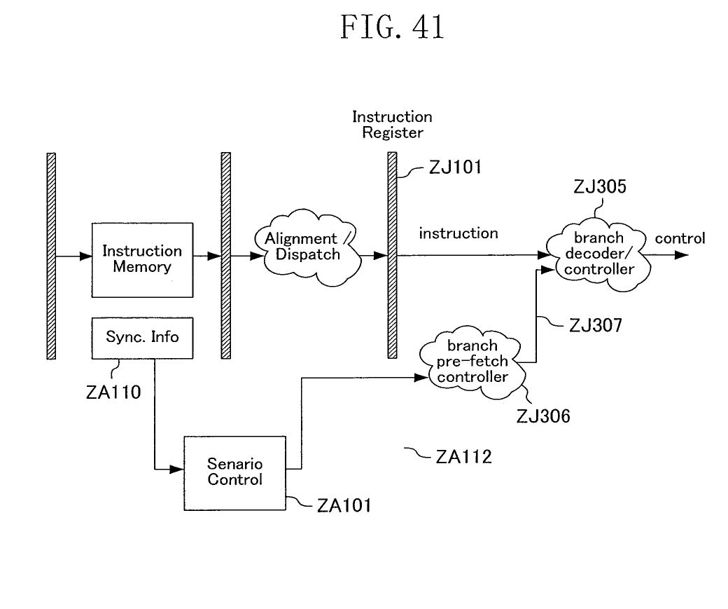

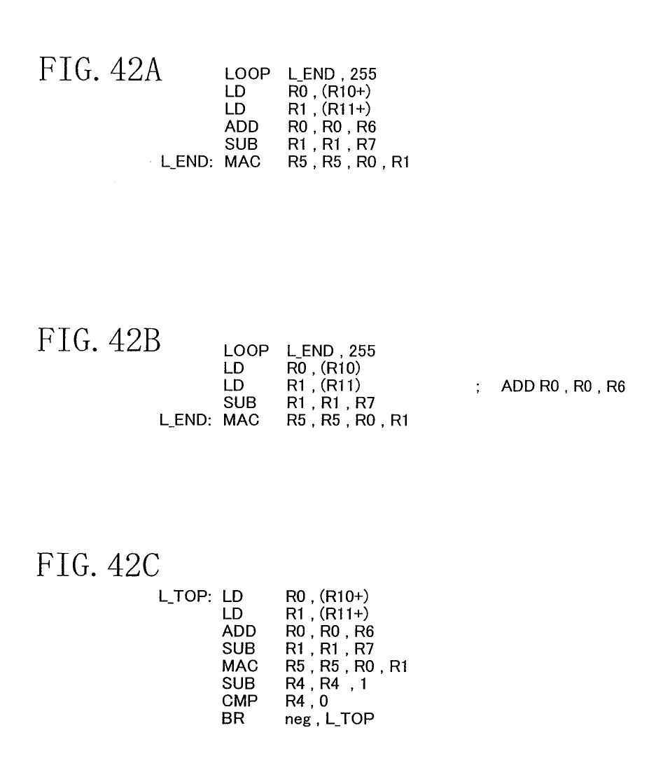

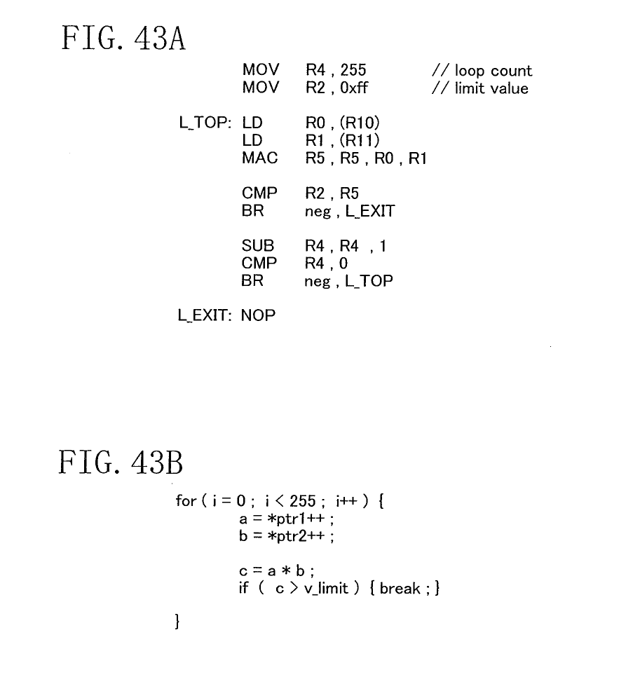

FIG. 41 shows another example of the state control device for a microprocessor in Embodiment 2 of the present invention.

Referring to FIG. 41, a branch controller ZJ305 can pre-fetch a branch target instruction in advance with a pre-fetch request ZJ307 supplied from a branch pre-fetch controller ZJ306. The branch pre-fetch controller ZJ306 performs control based on the control information ZA112 from the scenario control section ZA101, as in the example of FIG. 40.

In the illustrated example, also, a branch target instruction can be acquired prior to execution of the relevant branch instruction. Hence, the processing performance can be enhanced even with small-scale hardware without lowering software productivity.

In Embodiment 2, advance operations related to data memory access and fetch of a branch target instruction were described. Naturally, the present invention is also applicable to operations other than the above.

According to the present invention, advance and selective information supply is performed momentarily for information processing equipment in general, to perform state change of the equipment and thus attain enhancement in performance. Hence, state change of a processor itself, state change of a dynamic reconfigurable logic, drive of a peripheral expanded engine and the like can be inferred.

While the present invention has been described in preferred embodiments, it will be apparent to those skilled in the art that the disclosed invention may be modified in numerous ways and may assume many embodiments other than that specifically set out and described above. Accordingly, it is intended by the appended claims to cover all modifications of the invention which fall within the true spirit and scope of the invention.

1-35. (canceled)

36. A microprocessor comprising:
a pipeline comprising a plurality of pipeline stages including a dispatch stage, a decoding stage, an executing stage, and a write back stage, wherein the dispatch stage is adapted to issue multiple instructions in parallel;
an information recorder which stores in a scenario table an internal state, generated by a plurality of the pipeline stages at a first time, in association with a program counter value corresponding to an instruction being processed by the pipeline at the first time, in response to a conditional instruction being processed by the pipeline at the first time; and
an information player which supplies to the pipeline stages internal state information stored in the scenario table in response to the pipeline processing an instruction corresponding to a program counter value stored in the scenario table;
wherein processing of the conditional instruction is responsive to a predicate value such that, subsequent to processing of the conditional instruction by the decoding stage, in response to the predicate value being satisfied the executing stage performs a first execution operation and a second execution operation, and in response to the predicate value not being satisfied the executing stage performs the first execution operation without performing the second execution operation.

37. The microprocessor of claim 36, wherein
the internal state information stored in the scenario table includes at least one of
a number of instructions issued in the microprocessor,
a dependence between instructions issued in the microprocessor,
an instruction decoded state in the microprocessor,
a register access state in the microprocessor,
a hazard detection state in the microprocessor,
a data forwarding detection state in the microprocessor,
a data path selection state in the microprocessor,
function stop information in the microprocessor,
clock stop information in the microprocessor, and
a memory access state in the microprocessor.

38. The microprocessor of claim 36, wherein
the conditional instruction is a non-branching instruction.

39. The microprocessor of claim 36, wherein
the internal state is not generated in response to the predicate value.

40. The microprocessor of claim 36, wherein
storage by the information recorder is disabled in response to the predicate value not being satisfied.

41. The microprocessor of claim 36, wherein
storage by the information recorder is disabled in response to an instruction alignment failure.

42. The microprocessor of claim 36, wherein
storage by the information recorder is disabled in response to the predicate value not being satisfied.
